(19) United States
(12) Patent Application Publication
(10) Pub. No.: US 2015/0090708 A1
(43) Pub. Date: Apr. 2, 2015

(54) MICROWAVE HEATING APPARATUS AND PROCESSING METHOD

(71) Applicant: Tokyo Electron Limited, Tokyo (JP)

(72) Inventors: Sumi Tanaka, Yamanashi (JP); Taro Ikeda, Yamanashi (JP); Yoshiro Kabe, Yamanashi (JP); Kouji Shimomura, Yamanashi (JP); Seokhyoung Hong, Yamanashi (JP); Jun Yamashita, Yamanashi (JP); Masakazu Ban, Yamanashi (JP); Taichi Monden, Yamanashi (JP); Masayoshi Maenishi, Yamanashi (JP); Ryoji Yamazaki, Yamanashi (JP)

(21) Appl. No.: 14/381,235

(22) PCT Filed: Feb. 5, 2013
(86) PCT No.: PCT/JP2013/052561

§ 371 Date: Aug. 27, 2014

(30) Foreign Application Priority Data
Feb. 27, 2012 (JP) 2012-040095
Aug. 14, 2012 (JP) 2012-179803
Nov. 29, 2012 (JP) 2012-261338

(51) Int. Cl. H05B 6/70; H05B 6/80; H05B 6/64

(52) U.S. Cl. CPC H05B 6/707; H05B 6/6411; H05B 6/806
USPC 219/695; 219/754; 219/753; 219/690

(57) ABSTRACT

A microwave heating apparatus includes a processing chamber for accommodating a target, a support device for supporting the target in the processing chamber and a microwave introducing device for generating microwaves to introduce them into the processing chamber. The processing chamber further includes a top wall having a plurality of microwave introduction ports to introduce the microwaves generated in the microwave introducing device into the processing chamber. Each of the microwave introduction ports has a rectangular shape having long sides and short sides parallel to inner wall surfaces of four sidewalls of the processing chamber, and the support device includes a support member to support the target and a rotating mechanism for rotating the supported target.

### FIELD OF THE INVENTION

The present invention relates to a microwave heating apparatus for performing a process by introducing microwaves into a processing chamber and a processing method for heating a target object to be processed by using the microwave heating apparatus.

### BACKGROUND OF THE INVENTION

Along with miniaturization of LSI devices or memory devices, the depth of a diffusion layer in a transistor manufacturing process becomes shallower. Conventionally, activation of the doping atoms implanted into a diffusion layer is performed by a high-speed heating process referred to as a rapid thermal annealing (RTA) using a lamp heater. However, in the RTA process, as the diffusion of the doping atoms proceeds, the depth of the diffusion layer exceeds an allowable range, which causes difficulty in achieving a miniaturized design. Incomplete control of the depth of the diffusion layer is a factor to deteriorate the electrical characteristics of devices such as generation of leakage current.

Recently, as an apparatus for performing heat treatment on a semiconductor wafer, an apparatus using microwaves has been proposed. When the activation of the doping atoms is performed by microwave heating, the microwaves directly act on the doping atoms. Thus, it is advantageous in that excessive heating does not occur, and expansion of the diffusion layer can be suppressed.

As a heating apparatus using microwaves, for example, a microwave heating apparatus for heating a target by introducing microwaves into a pyramid-shaped horn through a rectangular waveguide has been proposed in Patent Document 1 (Japanese Patent Application Publication No. S62-268086). In Patent Document 1, the rectangular waveguide is rotated and arranged by an angle of 45 degrees in its axial direction with respect to the pyramid-shaped horn, so that two orthogonally polarized microwaves in a TE₁₀ mode can be irradiated onto the target in the same phase.

Further, as a heating apparatus for bending a target object to be heated, a microwave heating apparatus including a heating chamber having a square cross section whose size is set to about λ/2 to λ of a free space wavelength of the introduced microwaves has been proposed in Patent Document 2 (Japanese Utility Model Application Publication No. H6-17190).

The microwave has a wavelength which is as long as several tens of millimeters, and has a feature of easily forming a standing wave in the processing chamber. Thus, for example, when a semiconductor wafer is heated by microwaves, the intensity of an electromagnetic field becomes non-uniform in the plane of the semiconductor wafer, and non-uniformity of the heating temperature is likely to occur. In order to promote uniform diffusion of the microwaves in the processing chamber, it is known that a microwave radiation space is provided with a stirrer for stirring the microwaves. However, a stirring effect of the stirrer is small and, in a semiconductor process, particles may be generated from a rotary drive unit of the stirrer.

### SUMMARY OF THE INVENTION

The present invention provides a microwave heating apparatus and a processing method capable of performing uniform processing on a target object.

In accordance with an aspect of the present invention, there is provided a microwave heating apparatus including a processing chamber configured to accommodate a target object to be processed, the processing chamber including a microwave irradiation space, a support device configured to support the target object in the processing chamber, and a microwave introducing device configured to generate microwaves for heating the target object and introduce the microwaves into the processing chamber, wherein the processing chamber further includes a top wall, a bottom wall, and four sidewalls connected to each other, and wherein the top wall has a plurality of microwave introduction ports through which the microwaves generated in the microwave introducing device are introduced into the processing chamber. Each of the microwave introduction ports is formed in a rectangular shape having long sides and short sides in a plan view, and the long sides and the short sides are parallel to inner wall surfaces of the four sidewalls. Further, the support device includes a support member in contact with the target object to support the target object, and a rotating mechanism for rotating the target object supported by the support member.

In the microwave heating apparatus of the present invention, the support device may further include a vertical position adjusting mechanism for adjusting a vertical position of the target object supported by the support member.

In the microwave heating apparatus of the present invention, the microwave introduction ports may include a first to a fourth microwave introduction port. The first to the fourth microwave introduction port may be divided into two microwave introduction ports corresponding to an inner microwave radiation zone and two microwave introduction ports corresponding to an outer microwave radiation zone in an outward direction from a center of the top wall. In this case, the two microwave introduction ports corresponding to the inner microwave radiation zone may be arranged such that their centers are disposed on a circumference of an inner circle of two virtual concentric circles, and the two microwave introduction ports corresponding to the outer microwave radiation zone may be arranged such that their centers are disposed on a circumference of an outer circle of the two virtual concentric circles.

In the microwave heating apparatus of the present invention, the first to the fourth microwave introduction port may be arranged such that central axes parallel to the long sides of two microwave introduction ports which are adjacent to each other are perpendicular to each other, and the central axes of two microwave introduction ports which are not adjacent to each other do not overlap each other on a same straight line.

In the microwave heating apparatus of the present invention, the microwave introduction ports may be arranged such that distances from a center of the top wall are different from each other in the outward direction from a center of the top wall.

In the microwave heating apparatus of the present invention, a ratio L₁/L₂ of a length L₁ of the long sides to a length L₂ of the short sides of each of the microwave introduction ports may be equal to or greater than 4.

In the microwave heating apparatus of the present invention, the microwave introducing device may include at least one waveguide for transmitting the microwaves toward the processing chamber, and an adapter member which is mounted on an outside of the top wall of the processing chamber and includes a plurality of metallic block bodies, and the adapter member further may include at least one waveguide path for transmitting microwaves therein, the waveguide path having a substantially S-shape. In this case, one end of the waveguide path may be connected to a corresponding waveguide and the other end of the waveguide path is connected to a corresponding microwave introduction port, and the waveguide may be connected to the corresponding microwave introduction port such that they do not overlap each other at least partially in a vertical direction.

In accordance with another aspect of the present invention, there is provided a processing method for heating a target object to be processed by using a microwave heating apparatus which includes a processing chamber configured to accommodate the target object, the processing chamber having a microwave irradiation space, a support device configured to support the target object in the processing chamber, and a microwave introducing device configured to generate microwaves for heating the target object and introduce the microwaves into the processing chamber.

In the processing method of the present invention, the processing chamber further has a top wall, a bottom wall, and four sidewalls connected to each other, the top wall has a plurality of microwave introduction ports through which the microwaves generated in the microwave introducing device are introduced into the processing chamber. Each of the microwave introduction ports is formed in a rectangular shape having long sides and short sides in a plan view, the long sides and the short sides being parallel to inner wall surfaces of the four sidewalls. Further, the support device has a support member in contact with the target object to support the target object, and a rotating mechanism for rotating the target object supported by the support member. Furthermore, the microwave introduction ports are divided into microwave introduction ports corresponding to an inner microwave radiation zone and microwave introduction ports corresponding to an outer microwave radiation zone in a direction outward from a center of the top wall. Then, the processing method of the present invention processes the target object by introducing microwaves from each of the microwave introduction ports while rotating the target object supported by the support member by the rotating mechanism.

In the processing method of the present invention, the support device may further have a vertical position adjusting mechanism to adjust a vertical position of the target object supported by the support member. Then, the processing method of the present invention may include a first step of setting the vertical position of the target object to a first vertical position by the vertical position adjusting mechanism and processing the target object, and a second step of setting the vertical position of the target object to a second vertical position different from the first vertical position by the vertical position adjusting mechanism and processing the target object.

In the microwave heating apparatus and the processing method of the present invention, it is possible to perform uniform heating processing on a target object.

### BRIEF DESCRIPTION OF THE DRAWINGS

FIG. 1 is cross-sectional view showing a schematic configuration of a microwave heating apparatus according to a first embodiment of the present invention.

FIG. 2 is a cross-sectional view of main parts in the vicinity of a gate valve of FIG. 1.

FIG. 3 is an explanatory diagram showing a configuration example of support pins.

FIG. 4 is an explanatory diagram showing another configuration example of the support pins.

FIG. 5 is an explanatory diagram showing a schematic configuration of a high voltage power supply unit of a microwave introducing device of the first embodiment of the present invention.

FIG. 6 is a plan view showing a lower surface of a ceiling portion of a processing chamber shown in FIG. 1.

FIG. 7 is an explanatory diagram showing an enlarged view of a microwave introduction port.

FIG. 8 is a plan view showing the lower surface of the ceiling portion of the processing chamber for explaining a first modification of the arrangement of the microwave introduction ports.

FIG. 9 is a plan view showing the lower surface of the ceiling portion of the processing chamber for explaining a second modification of the arrangement of the microwave introduction ports.

FIG. 10 is a plan view showing the lower surface of the ceiling portion of the processing chamber for explaining a third modification of the arrangement of the microwave introduction ports.

FIG. 11 is a diagram for explaining an opening and closing operation of the chamber in the microwave heating apparatus according to the first embodiment of the present invention.

FIG. 12 is a diagram showing the state in which an upper unit is pulled out from the state of FIG. 11.

FIG. 13 is a diagram showing the state in which the upper unit is moved by changing a sliding direction of the upper unit from the state of FIG. 12.

FIG. 14 is an explanatory diagram showing a configuration of a control unit shown in FIG. 1.

FIG. 15 is a diagram showing the simulation results of power absorption efficiency in the case of changing the arrangement of the microwave introduction ports in the X-axis direction.

FIG. 16 is a diagram showing the simulation results of power absorption efficiency in the case of changing the arrangement of the microwave introduction ports in the Y-axis direction.

FIG. 17 is an explanatory diagram schematically showing a configuration of the microwave heating apparatus in which corner portions are rounded and which is used in the simulation.

FIG. 18 is a diagram showing results of the simulation using the microwave heating apparatus in which the corner portions are rounded.

FIG. 19 is a graph showing experimental results obtained by measuring a temperature change in the plane of the semiconductor wafer when an annealing process was performed by changing the vertical position of the wafer.

FIG. 20 is a graph showing the measurement results of sheet resistance in the plane of the semiconductor wafer when an annealing process was performed by changing the vertical position of the wafer.

FIG. 21 is a graph showing the measurement results of the temperature of the wafer W under conditions A and B of Experiment 3.

FIG. 22 is a graph showing the measurement results of the microwave reflection amount under conditions A and B of Experiment 3.

FIG. 23 is a graph showing the measurement results of the temperature of the semiconductor wafer when an annealing process was performed by changing the vertical position of the wafer under condition C of Experiment 3.

FIG. 24 is a graph showing the measurement results of the microwave reflection amount under condition C of Experiment 3.

FIG. 25 is a graph showing the measurement results of the maximum temperature of the wafer when an annealing process was performed by changing the vertical position of the wafer in Experiment 4.

FIG. 26 is a graph showing the measurement results of the microwave reflection amount when an annealing process was performed by changing the vertical position of the wafer in Experiment 5.

FIG. 27 is an explanatory diagram schematically showing electromagnetic field vectors of microwaves radiated from the microwave introduction ports.

FIG. 28 is another explanatory diagram schematically showing electromagnetic field vectors of microwaves radiated from the microwave introduction ports.

FIG. 29 is a cross-sectional view showing a schematic configuration of a microwave heating apparatus according to a second embodiment of the present invention.

FIG. 30 is an explanatory diagram showing the state in which a microwave introducing adaptor is mounted on the ceiling portion.

FIG. 31 is an explanatory diagram showing a structure of a groove formed in the microwave introducing adaptor.

### DETAILED DESCRIPTION OF THE EMBODIMENTS

Hereinafter, embodiments of the present invention will be described in detail with reference to the drawings.

### First Embodiment

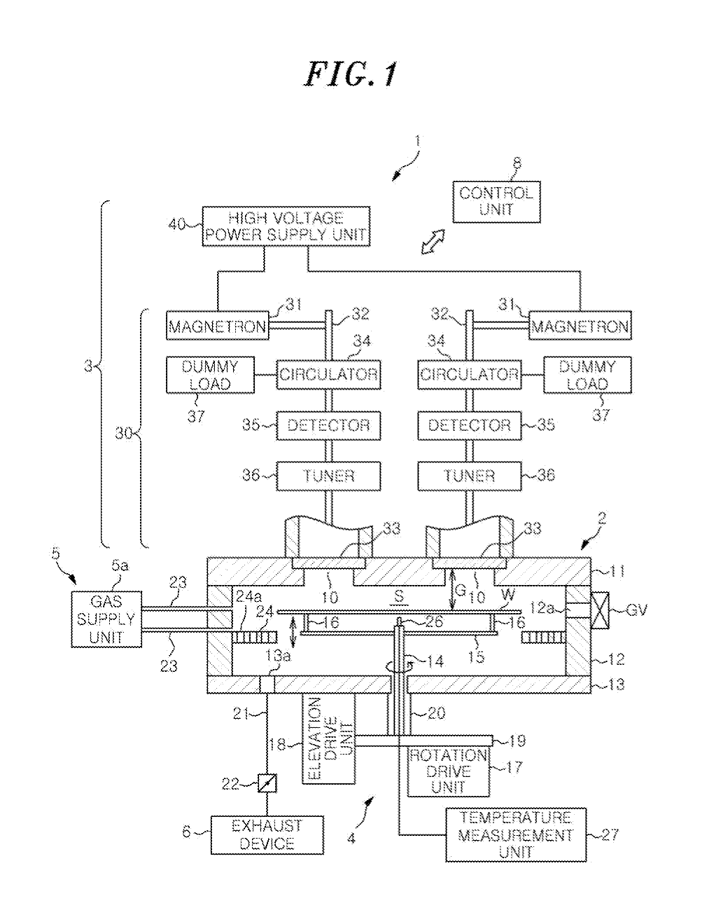

First, a schematic configuration of a microwave heating apparatus according to a first embodiment of the present invention will be described with reference to FIG. 1. FIG. 1 is a cross-sectional view showing a schematic configuration of a microwave heating apparatus according to the present embodiment. A microwave heating apparatus 1 according to the present embodiment is the apparatus which performs an annealing process on, e.g., a semiconductor wafer (hereinafter, simply referred to as “wafer”) W for manufacturing a semiconductor device by irradiating microwaves to the wafer W in accordance with multiple consecutive operations.

The microwave heating apparatus 1 includes a processing chamber 2 for accommodating the wafer W as a target object to be processed, a microwave introducing device 3 for introducing microwaves into the processing chamber 2, a support device 4 for supporting the wafer W in the processing chamber 2, a gas supply mechanism 5 for supplying a gas into the processing chamber 2, an exhaust device 6 for vacuum-evacuating the processing chamber 2, and a control unit 8 for controlling the respective components of the microwave heating apparatus 1.

<Processing Chamber>

The processing chamber 2 is made of a metal material. As a material for forming the processing chamber 2, for example, aluminum, aluminum alloy, stainless steel or the like may be used. The microwave introducing device 3 is provided at the top of the processing chamber 2 and functions as a microwave introducing unit for introducing electromagnetic waves (microwaves) into the processing chamber 2. A configuration of the microwave introducing device 3 will be described in detail later.

The processing chamber 2 has a plate-shaped ceiling portion 11 serving as an upper wall, a bottom portion 13 serving as a bottom wall, and four sidewall portions 12 serving as sidewalls connecting the ceiling portion 11 and the bottom portion 13. Further, the processing chamber 2 has microwave introduction ports 10 provided to vertically pass through the ceiling portion 11, a loading and unloading port 12a provided in one of the sidewall portions 12, and an exhaust port 13a provided in the bottom portion 13. In this case, the four sidewall portions 12 are connected at a right angle to have a rectangular tube shape in a horizontal plan view. Thus, the processing chamber 2 forms a cube shape having a cavity therein. Further, the inner surface of each of the sidewall portions 12 is flattened, and functions as a reflecting surface for reflecting microwaves.

In the microwave heating apparatus 1 according to the present embodiment, all inner wall surfaces (i.e., the inner side of the ceiling portion 11, the four sidewall portions 12 and the bottom portion 13) of the processing chamber 2 are mirror-finished. By mirror-finishing the inner wall surfaces of the processing chamber 2, it is possible to improve the reflection efficiency of radiant heat from the wafer W. Further, since it is possible to reduce the surface area of the inner wall surfaces of the processing chamber 2 by mirror finishing, it is possible to reduce the microwaves absorbed into the walls of the processing chamber 2, thereby improving the reflection efficiency of the microwaves.

Therefore, it is possible to efficiently perform the annealing process on the wafer W, and to increase the attainment temperature of the wafer W as compared with a case where mirror finishing is not performed. Further, the processing chamber 2 may be manufactured by machining. In this case, since it is practically impossible to form corner portions such as a joint between the sidewall portions 12 and a joint between the bottom portion 13 and the sidewall portions 12 at a right angle, a rounding process may be performed on the corner portions. It can be seen from the results of a simulation that in the rounding process, a radius of curvature R_{c} is preferably in a range from 15 mm to 16 mm to suppress the reflection into the microwave introduction ports 10 (see FIG. 18).

The loading and unloading port 12a is used in loading and unloading the wafer W between the processing chamber 2 and a transfer chamber (not shown) adjacent to the processing chamber 2. A gate valve GV is provided between the processing chamber 2 and the transfer chamber (not shown). The gate valve GV has a function of opening and closing the loading and unloading port 12a, and allows the wafer W to be transferred between the transfer chamber (not shown) and the processing chamber 2 in an open state while air-tightly sealing the processing chamber 2 in a closed state.

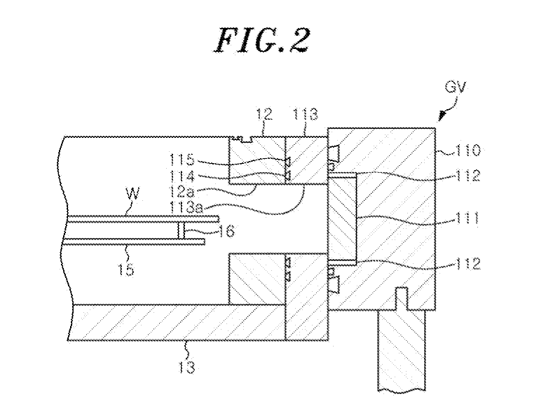

FIG. 2 is a cross-sectional view of main parts in the vicinity of the gate valve GV of the processing chamber 2. The gate valve GV has a main body 110, a plate-shaped block 111 inserted into a recess of the main body 110, and a drive mechanism (not shown). The main body 110 and the block 111 constitute a valve body. The drive mechanism displaces the valve body vertically and horizontally. The main body 110 and the block 111 are formed of, e.g., metal such as aluminum or stainless steel. The block 111 is a replaceable consumable part because it is exposed to a space in the processing chamber 2. A gap 112 is provided between the main body 110 and the block 111 to form a choke structure for preventing leakage of microwaves.

A frame 113 for contacting the gate valve GV is interposed between the gate valve GV and the sidewall portions 12 of the processing chamber 2. The frame 113 is formed of, e.g., metal such as aluminum or stainless steel. The frame 113 is a replaceable consumable part because it is exposed to the space in the processing chamber 2. The frame 113 is provided with an opening 113a having a size corresponding approximately to the loading and unloading port 12a. Between the frame 113 and the sidewall portions 12 of the processing chamber 2, an electromagnetic shield member 114 and an O-ring 115 are disposed so as to surround the opening 113a. As shown in FIG. 2, the electromagnetic shield member 114 is disposed inwardly, and the O-ring 115 is disposed outwardly.

The main body 110 and the block 111 serving as a valve body are provided to be displaceable in vertical and horizontal directions by a drive unit (not shown). Thus, opening and closing of the gate valve GV are performed. Further, for example, in the case of performing the opening and closing by displacing the valve body in an oblique direction, the inner surface of the block 111 which is exposed to the inside of the processing chamber 2 becomes an inclined surface, which may affect the reflection of microwaves. In this case, for example, a reflecting plate may be mounted on the inner wall surface of the block 111 to correct the inclined surface and to form a vertical surface.

<Support Device>

The support device 4 has a hollow tubular shaft 14 extending to the outside of the processing chamber 2 through the approximate center of the bottom portion 13 of the processing chamber 2, a plurality of (e.g., three) arm portions 15 provided in a substantially horizontal direction from the vicinity of the upper end of the shaft 14, and a plurality of support pins 16 detachably mounted on the arm portions 15, respectively. Further, the support device 4 has a rotation drive unit 17 for rotating the shaft 14, an elevation drive unit 18 for vertically displacing the shaft 14, and a movable coupling unit 19 for connecting the rotation drive unit 17 to the elevation drive unit 18 while supporting the shaft 14. The rotation drive unit 17, the elevation drive unit 18 and the movable coupling unit 19 are provided outside the processing chamber 2. Further, in the case of setting the inside of the processing chamber 2 to a vacuum state, a sealing mechanism 20 such as a bellows may be provided around a portion where the shaft 14 passes through the bottom portion 13.

In the support device 4, the shaft 14, the arm portions 15, the rotation drive unit 17 and the movable coupling unit 19 constitute a rotating mechanism for rotating the wafer W held on the support pins 16 in the horizontal direction. Further, in the support device 4, the shaft 14, the arm portions 15, the elevation drive unit 18 and the movable coupling unit 19 constitute a vertical position adjusting mechanism for adjusting the vertical position of the wafer W held on the support pins 16. The support pins 16 support the wafer W in contact with a back surface of the wafer W in the processing chamber 2.

The support pins 16 are disposed such that upper end portions thereof are arranged in the circumferential direction of the wafer W. By the rotation drive unit 17, the arm portions 15 rotate around the shaft 14 to revolve the support pins 16 in the horizontal direction. Further, by the elevation drive unit 18, the support pins 16 and the arm portions 15 are displaced up and down in the vertical direction with the shaft 14. In order to keep the horizontal level of the wafer W to be supported by the arm portions 15 and the support pins 16, the support device 4 has a mechanism (not shown) for adjusting the inclination of the shaft 14.

Further, in order to prevent leakage of microwaves through the support device 4, prevent abnormal discharge, and prevent generation of particles from moving parts, the following measures have been taken in the support device 4. First, in order to prevent the leakage of microwaves through the support device 4, in the tubular shaft 14, a double choke structure is provided although not illustrated. Further, a ground terminal such as a shield finger (not shown) is attached to the shaft 14 and is maintained at a ground potential. Furthermore, since particles are likely to be generated from the moving parts in the hollow shaft 14, there is provided an exhaust and purge mechanism (not shown) for evacuating or purging the inside of the hollow shaft 14.

The support pins 16 and the arm portions 15 are made of a dielectric material. As a material forming the support pins 16 and the arm portions 15, e.g., quartz or ceramic may be used.

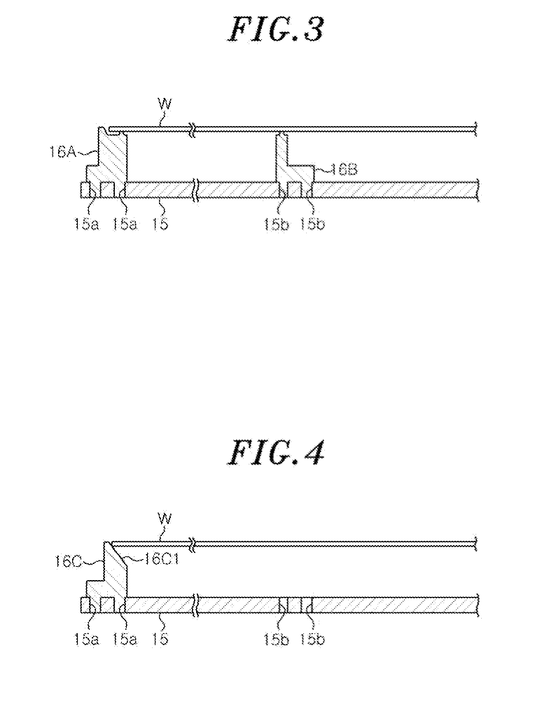

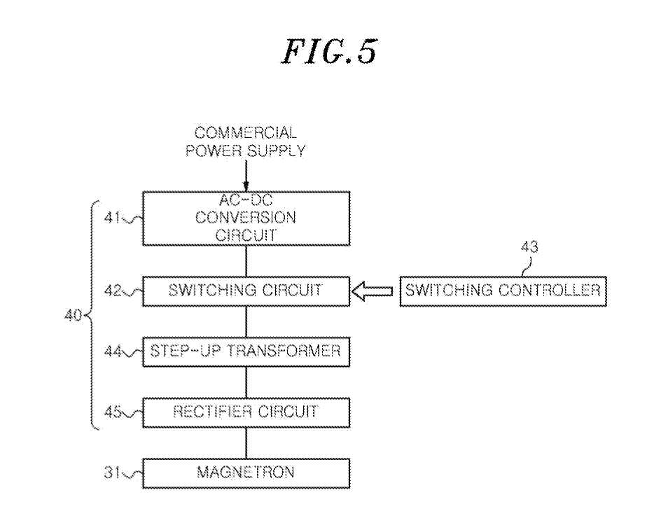

FIGS. 3 and 4 show an exemplary configuration of the support pins 16 mounted on the arm portions 15. First, FIG. 3 illustrates the state where two support pins 16A and 16B are mounted on one arm portion 15. The support pin 16A is in contact with the back surface in the vicinity of an outer peripheral portion of the wafer W to support the wafer W, and the support pin 16B is in contact with the back surface of the wafer W at a position closer to the radial inner side of the wafer W than the support pin 16A. The support pin 16A is detachably mounted by being inserted into mounting holes 15a provided in the arm portion 15. The support pin 16B is detachably mounted by being inserted into mounting holes 15b provided in the arm portion 15.

Thus, by providing two mounting holes 15a and two mounting holes 15b, the support pin 16A and the support pin 16B can be reliably fixed to the arm portion 15. Therefore, it is possible to prevent the support pin 16A and the support pin 16B from falling off by, e.g., electrostatic adsorption to the wafer W. Further, since the support pin 16A and the support pin 16B are fixed by being inserted into the mounting holes 15a and the mounting holes 15b, it is possible to reduce the generation of particles as compared to a screwing method or the like.

FIG. 4 shows the state in which the support pin 16A is replaced with a support pin 16C and the support pin 16B is removed from the state of FIG. 3. The support pin 16C has an inclined surface 16C1 in contact with a bevel portion of the wafer W to support the wafer W.

As shown in FIGS. 3 and 4, in the microwave heating apparatus 1 of the present embodiment, by using the detachable support pins 16, the contact state of the support pins 16 with the wafer W, and the mounting position, the shape, the number of the support pins 16 mounted on the arm portion 15 and the like may be selected appropriately.

The rotation drive unit 17 is not particularly limited as long as it can rotate the shaft 14, and for example, may include a motor (not shown) or the like. The elevation drive unit 18 is not particularly limited as long as it can vertically displace the shaft 14 and the movable coupling unit 19, and for example, may include a ball screw (not shown) or the like. The rotation drive unit 17 and the elevation drive unit 18 may be formed as a single mechanism, and may be configured without the movable coupling unit 19. Further, the rotating mechanism for rotating the wafer W in the horizontal direction and the vertical position adjusting mechanism for adjusting the vertical position of the wafer W may have other configurations as long as they can achieve these purposes.

<Exhaust Mechanism>

The exhaust device 6 has a vacuum pump such as a dry pump. The microwave heating apparatus 1 further includes an exhaust pipe 21 for connecting the exhaust port 13a to the exhaust device 6 and a pressure regulating valve 22 provided in the exhaust pipe 21. By operating the vacuum pump of the exhaust device 6, an inner space of the processing chamber 2 is vacuum-evacuated. Further, the microwave heating apparatus 1 may also perform processing at an atmospheric pressure, in which case the vacuum pump is not required. Instead of using a vacuum pump such as a dry pump as the exhaust device 6, exhaust equipment provided in facilities in which the microwave heating apparatus 1 is installed may be used.

<Gas Introduction Mechanism>

The microwave heating apparatus 1 further includes the gas supply mechanism 5 for supplying a gas into the processing chamber 2. The gas supply mechanism 5 includes a gas supply device 5a having a gas supply source (not shown), and a plurality of pipes 23 connected to the gas supply device 5a to introduce a processing gas into the processing chamber 2. The plurality of pipes 23 are connected to the sidewall portions 12 of the processing chamber 2.

The gas supply device 5a is configured to supply a gas such as N₂, Ar, He, Ne, O₂ and H₂ as a processing gas or a cooling gas into the processing chamber 2 through the pipes 23 in a side flow manner. The supply of gas into the processing chamber 2 may be carried out, for example, by a gas supply unit provided at a position (e.g., the ceiling portion 11) opposite to the wafer W. Further, instead of the gas supply device 5a, an external gas supply device which is not included in the configuration of the microwave heating apparatus 1 may be used. Although not shown, the microwave heating apparatus 1 further includes a mass flow controller and an opening and closing valve which are provided in the pipes 23. The type of gas supplied into the processing chamber 2, the flow rate of the gas and the like are controlled by the mass flow controller and the opening and closing valve.

<Rectifying Plate>

The microwave heating apparatus 1 further includes a rectifying plate 24 having a frame shape around the support pins 16 in the processing chamber 2 between the sidewall portions 12 and the support pins 16. The rectifying plate 24 has a plurality of rectifying holes 24a which are provided so as to vertically pass through the rectifying plate 24. The rectifying plate 24 rectifies an atmosphere of a region in which the wafer W is to be disposed in the processing chamber 2, and makes it flow toward the exhaust port 13a. The rectifying plate 24 is formed of a metal material such as aluminum, aluminum alloy, or stainless steel. Further, the rectifying plate 24 is not an essential component in the microwave heating apparatus 1, and may be omitted.

<Temperature Measurement Unit>

The microwave heating apparatus 1 further includes a plurality of radiation thermometers 26 for measuring a surface temperature of the wafer W, and a temperature measurement unit 27 connected to the radiation thermometers 26. In FIG. 1, only the radiation thermometer 26 for measuring the temperature of the central portion of the back surface of the wafer W through the hollow shaft 14 is illustrated and the others are omitted.

<Microwave Radiation Space>

In the microwave heating apparatus 1 of the present embodiment, in the processing chamber 2, a space defined by the ceiling portion 11, the four sidewall portions 12 and the rectifying plate 24 forms a microwave radiation space S. Microwaves are radiated into the microwave radiation space S from the microwave introduction ports 10 provided in the ceiling portion 11. Since the ceiling portion 11, the four sidewall portions 12 and the rectifying plate 24 of the processing chamber 2 are formed of a metal material, the microwaves are reflected and scattered into the microwave radiation space S.

<Microwave Introducing Device>

Next, a configuration of the microwave introducing device 3 will be described with reference to FIGS. 1 and 5. FIG. 5 is a diagram showing a schematic configuration of a high voltage power supply unit of the microwave introducing device 3.

As described above, the microwave introducing device 3 is provided at the top of the processing chamber 2, and functions as a microwave introducing unit for introducing electromagnetic waves (microwaves) to the processing chamber 2. As shown in FIG. 1, the microwave introducing device 3 includes a plurality of microwave units 30 for introducing microwaves into the processing chamber 2, and a high voltage power supply unit 40 connected to the microwave units 30.

(Microwave Units)

In this embodiment, the microwave units 30 have the same configuration. Each of the microwave units 30 has a magnetron 31 to generate microwaves for processing the wafer W, a waveguide 32 to transmit the microwaves generated in the magnetron 31 to the processing chamber 2, and a transmission window 33 fixed to the ceiling portion 11 to cover the microwave introduction port 10. The magnetron 31 corresponds to a microwave source in the present invention.

The magnetron 31 has an anode and a cathode (all not shown) to which a high voltage supplied by the high voltage power supply unit 40 is applied. Further, as the magnetron 31, a component capable of oscillating microwaves of various frequencies may be used. The microwave generated by the magnetron 31 is selected to have an optimal frequency for each process of a target object. For example, for the annealing process, a microwave with a high frequency of 2.45 GHz, 5.8 GHz or the like is preferable, and a microwave of 5.8 GHz is particularly preferable.

The waveguide 32 has a square tubular shape having a rectangular cross section, and extends upward from the top surface of the ceiling portion 11 of the processing chamber 2. The magnetron 31 is connected to the vicinity of the upper end of the waveguide 32. The lower end of the waveguide 32 is in contact with the upper surface of the transmission window 33. The microwave generated by the magnetron 31 is introduced into the processing chamber 2 through the waveguide 32 and the transmission window 33.

The transmission window 33 is formed of a dielectric material. As the material of the transmission window 33, for example, quartz, ceramics or the like may be used. The gap between the transmission window 33 and the ceiling portion 11 is air-tightly sealed by a sealing member (not shown). A distance (gap G) from the lower surface of the transmission window 33 to the front surface of the wafer W supported by the support pins 16 is preferably equal to or greater than, e.g., 25 mm, and is more preferably adjusted to vary within a range from 25 mm to 50 mm in terms of suppressing the microwaves from being radiated directly to the wafer W.

The microwave unit 30 further includes a circulator 34, a detector 35 and a tuner 36 provided in the waveguide 32, and a dummy load 37 connected to the circulator 34. The circulator 34, the detector 35 and the tuner 36 are arranged in this order from the upper end side of the waveguide 32. The circulator 34 and the dummy load 37 constitute an isolator to separate reflected waves from the processing chamber 2. That is, the circulator 34 guides the reflected waves from the processing chamber 2 to the dummy load 37, and the dummy load 37 converts the reflected waves guided by the circulator 34 into heat.

In the present embodiment, for example, four microwave units 30 are provided. Although not shown, the magnetrons 31 of the four microwave units 30 are unevenly distributed above the ceiling portion 11 so as to be close to each other. As a result, the shapes of the waveguides 32 between the circulators 34 and the magnetrons 31 in the microwave units 30 are different from each other. Therefore, by arranging the magnetrons 31 to be concentrated in close proximity, it is possible to facilitate maintenance of the magnetrons 31.

The detector 35 detects the reflected waves from the processing chamber 2 in the waveguide 32. The detector 35 is configured as, e.g., an impedance monitor, in particular, a standing wave monitor for detecting an electric field of standing waves in the waveguide 32. The standing wave monitor may include, e.g., three pins protruding into an inner space of the waveguide 32. By detecting the location, phase and strength of the electric field of standing waves by the standing wave monitor, it is possible to detect the reflected waves from the processing chamber 2. Also, the detector 35 may be configured as a directional coupler capable of detecting traveling waves and reflected waves.

The tuner 36 has a function of matching the impedance between the magnetron 31 and the processing chamber 2. Impedance matching by the tuner 36 is performed based on the detection result of the reflected waves in the detector 35. The tuner 36 may be configured as a conductive plate (not shown) capable of moving into and out of the inner space of the waveguide 32. In this case, by controlling the protrusion amount of the conductive plate into the inner space of the waveguide 32, it is possible to adjust the amount of power of the reflected waves, and to adjust the impedance between the magnetron 31 and the processing chamber 2.

(High Voltage Power Supply Unit)

The high voltage power supply unit 40 supplies a high voltage to the magnetron 31 to generate the microwaves. As shown in FIG. 5, the high voltage power supply unit 40 includes an AC-DC conversion circuit 41 connected to a commercial power supply, a switching circuit 42 connected to the AC-DC conversion circuit 41, a switching controller 43 for controlling operation of the switching circuit 42, a step-up transformer 44 connected to the switching circuit 42, and a rectifier circuit 45 connected to the step-up transformer 44. The magnetron 31 is connected to the step-up transformer 44 via the rectifier circuit 45.

The AC-DC conversion circuit 41 is a circuit for rectifying an alternating current (e.g., three-phase AC 200V) from the commercial power supply and converting the alternating current into a direct current of a predetermined waveform. The switching circuit 42 is a circuit for controlling on/off of the direct current converted by the AC-DC conversion circuit 41. In the switching circuit 42, phase shift type Pulse Width Modulation (PWM) control or Pulse Amplitude Modulation (PAM) control is conducted by the switching controller 43, and a pulsed voltage waveform is generated. The step-up transformer 44 steps up the voltage waveform outputted from the switching circuit 42 to a predetermined magnitude. The rectifier circuit 45 is a circuit for rectifying the voltage stepped up by the step-up transformer 44 and supplying the voltage to the magnetron 31.

<Arrangement of Microwave Introduction Ports>

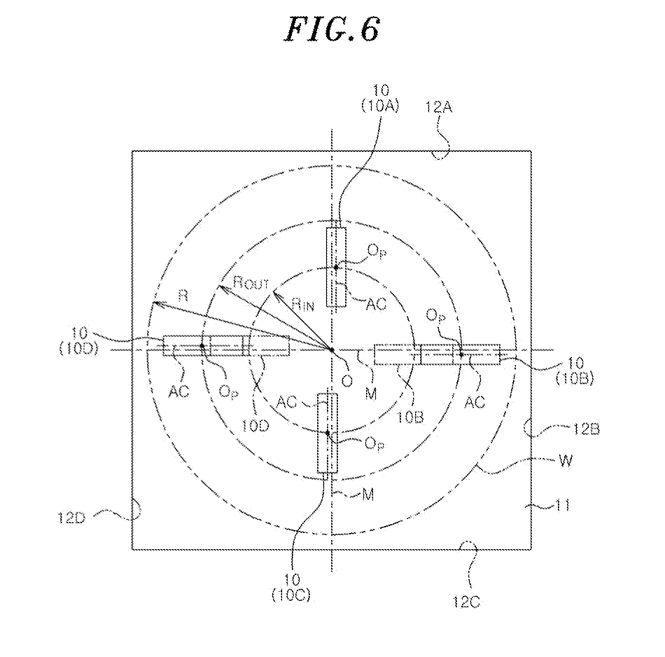

Next, the arrangement of the microwave introduction ports 10 in the present embodiment will be described in detail with reference to FIGS. 1, 6 and 7. FIG. 6 shows a state of the lower surface of the ceiling portion 11 of the processing chamber 2 shown in FIG. 1, which is viewed from the inside of the processing chamber 2. In FIG. 6, the position and size of the wafer W are shown by a dashed double-dotted line to overlap with the ceiling portion 11. Reference symbol O represents the center of the wafer W, and in the present embodiment, also represents the center of the ceiling portion 11. Two lines passing through reference symbol O represent center lines M connecting the midpoints of opposite sides in four sides serving as a boundary between the ceiling portion 11 and the sidewall portions 12.

Further, the center of the wafer W and the center of the ceiling portion 11 may not overlap each other necessarily. In FIG. 6, for simplicity of description, joint portions between the inner wall surfaces of the four sidewall portions 12 of the processing chamber 2 and the ceiling portion 11 are denoted by reference numeral 12A, 12B, 12C, and 12D to distinguish the four sidewall portions 12 from each other and indicate their locations. Further, FIG. is an enlarged plan view showing one of the microwave introduction ports 10.

As shown in FIG. 6, in this embodiment, as a plurality of microwave introduction ports, there are provided the four microwave introduction ports 10 arranged to form a substantially cross shape as a whole in the ceiling portion 11. Hereinafter, when the four microwave introduction ports 10 are expressed to be distinguished from each other, they are denoted by reference numeral 10A, 10B, 10C, and 10D. Further, in the present embodiment, the microwave units 30 are connected to the microwave introduction ports 10, respectively. That is, the number of the microwave units 30 is four. In this embodiment, a case where the four microwave introduction ports 10A, 10B, 10C and 10D are provided as a plurality of microwave introduction ports is described as an example, but the number of the microwave introduction ports 10 is arbitrary, and for example, may be in a range from 2 to 8.

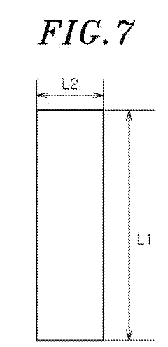

As shown in FIG. 7, each of the four microwave introduction ports 10 has a rectangular shape having long and short sides in its plan view. A ratio L₁/L₂ of a length L₁ of the long sides to a length L₂ of the short sides of the microwave introduction port 10 is, for example, in a range from 2 to 100, preferably, equal to or greater than 4, and more preferably, in a range from 5 to 20. The ratio L₁/L₂ is set to be 2 or more, preferably, 4 or more in order to strengthen the directivity of microwaves radiated into the processing chamber 2 from the microwave introduction port 10 in a direction perpendicular to the long side (direction parallel to the short side) of the microwave introduction port 10.

If the ratio L₁/L₂ is less than 2, the microwaves radiated into the processing chamber 2 from the microwave introduction port 10 are likely to be oriented in a direction parallel to the long side (direction perpendicular to the short side) of the microwave introduction port 10. Further, if the ratio L₁/L₂ is less than 2, the directivity of the microwaves becomes strong immediately below the microwave introduction port 10. Thus, when the gap G is small, microwaves are irradiated directly to the wafer W, and local heating is likely to occur. On the other hand, if the ratio L₁/L₂ exceeds 20, since the directivity of the microwaves becomes excessively weak in a direction parallel to the long side (direction perpendicular to the short side) of the microwave introduction port 10 or immediately below the microwave introduction port 10, the heating efficiency of the wafer W may be reduced.

Further, the length L1 of the long sides of the microwave introduction port 10 is preferable to meet L₁=n×λg/2 (n is an integer) for, e.g., a guide wavelength Ag of the waveguide 32, and n=2 is more preferable. The ratio L₁/L₂ or the size of each of the microwave introduction ports 10 may be different, but from the viewpoint of improving the controllability while enhancing the uniformity of heating processing on the wafer W, it is preferable that all of the four microwave introduction ports 10 have the same size and shape.

Further, in the present embodiment, from the viewpoint of making uniform the electric field distribution on the wafer W, in the ceiling portion 11, the four microwave introduction ports 10 are disposed at different positions in an outward direction from the center O of the ceiling portion 11 (wafer W) such that each of the centers Oₚ overlaps with one of two concentric circles. That is, the four microwave introduction ports 10 do not have the same position in the radial direction of the wafer W, and are disposed at different positions in the radial direction to form a plurality of radiation zones on the wafer W.

For example, as shown in FIG. 6, the four microwave introduction ports 10 include two sets disposed at different positions for forming an inner microwave radiation zone and an outer microwave radiation zone. Specifically, the microwave introduction ports 10A and 10C, which are not adjacent to each other in the circumferential direction of the wafer W, are disposed such that the centers Oₚ thereof lie on a virtual circle having a radius R_{IN} with respect to the center O of the wafer W, thereby forming the inner microwave radiation zone. Also, the microwave introduction ports 10B and 10D, which are not adjacent to each other in the circumferential direction of the wafer W, are disposed such that the centers Oₚ thereof lie on a virtual circle having a radius R_{OUT} with respect to the center O of the wafer W, thereby forming the outer microwave radiation zone. In this case, the centers of two virtual concentric circles coincide with the center O (center of the wafer W) of the ceiling portion 11, and the radius R_{IN} is smaller than the radius R_{OUT} (R_{IN}<R_{OUT}).

In the example shown in FIG. 6, the microwave introduction ports 10A and 10C are disposed at a reference position of the microwave introduction ports 10. When all of the four microwave introduction ports 10 are disposed at the reference position, all of the centers Oₚ of the four microwave introduction ports 10 are located on the virtual circle having the radius R_{IN}. In this case, in a plane parallel to the lower surface of the ceiling portion 11, a direction perpendicular to the long side of each of the microwave introduction ports 10 is set as an X-axis, and a direction parallel to the long side of each of the microwave introduction ports 10 is set as a Y-axis. In the example shown in FIG. 6, each of the microwave introduction ports 10B and 10D is disposed to be translated by a distance R_{OUT}-R_{IN} in the Y-axis direction from the reference position (shown by an imaginary line in FIG. 6).

In the example shown in FIG. 6, the microwave introduction ports 10 are arranged to radiate microwaves into two divided regions of the inner microwave radiation zone and the outer microwave radiation zone. In this case, when the radius of the wafer W is R, under the condition of R_{IN}<R_{OUT}, for example, the radius R_{IN} indicating the reference position is preferable to satisfy R/5≦R_{IN}≦3R/5, and the radius R_{OUT} is preferable to satisfy 2R/5≦R_{OUT}≦5R/5. For example, in the case of the wafer W having a diameter of 300 mm, under the condition of R_{IN}<R_{OUT}, the radius R_{IN} is preferably set in a range from 30 mm to 90 mm, and the radius R_{OUT} is preferably set in a range from 60 mm to 150 mm.

Thus, the microwave introduction ports 10 are arranged to radiate microwaves into two divided regions of the inner microwave radiation zone and the outer microwave radiation zone. With this configuration, in the present embodiment, when the wafer W on the support pins 16 is rotated horizontally by driving the rotation drive unit 17, it is possible to enhance the heating uniformity in the radial direction of the wafer W in addition to the heating uniformity in the circumferential direction of the wafer W.

Further, in the present embodiment, the long sides and the short sides of each of the four microwave introduction ports 10 are provided to be parallel to the inner wall surfaces of the four sidewall portions 12A, 12B, 12C and 12D. For example, in FIG. 6, the long sides of the microwave introduction port 10A are parallel to the sidewall portions 12B and 12D, and the short sides of the microwave introduction port 10A are parallel to the sidewall portions 12A and 12C. Most of the microwaves radiated from the microwave introduction port 10A travel and propagate in the X-axis direction perpendicular to the long side (direction parallel to the short side) thereof. Further, the microwaves radiated from the microwave introduction port 10A are reflected by each of the two sidewall portions 12B and 12D.

Since the sidewall portions 12B and 12D are provided to be parallel to the long side of the microwave introduction port 10A, the directivity (electromagnetic field vector) of reflected waves is opposite by 180 degrees to the directivity (electromagnetic field vector) of traveling waves, and scattering in the direction toward the other microwave introduction ports 10B, 10C and 10D hardly occurs. Thus, by arranging the four microwave introduction ports 10 having the ratio L₁/L₂ of, e.g., 2 or more such that the long sides and the short sides of each of the four microwave introduction ports 10 are parallel to the inner wall surfaces of the four sidewall portions 12A, 12B, 12C and 12D, it is possible to control the directions of the microwaves radiated from the microwave introduction ports 10 and the reflected waves thereof.

Further, in this embodiment, the four microwave introduction ports 10 having the ratio L₁/L₂ of, e.g., 2 or more are arranged such that when each of the microwave introduction ports 10 is translated in the X-axis direction perpendicular to the long side thereof, it does not overlap the other microwave introduction ports 10 having a long side parallel thereto. For example, in FIG. 6, the microwave introduction ports 10A˜10D are arranged to form a cross shape as a whole. That is, two microwave introduction ports 10 adjacent to each other are arranged to be shifted by 90 degrees such that central axes AC parallel to the long sides thereof are perpendicular to each other.

Further, even when the microwave introduction port 10A is translated in the X-axis direction perpendicular to the long side thereof, it does not overlap the other microwave introduction port 10C having a long side parallel to that of the microwave introduction port 10A. In other words, within a range of the length of the long side of the microwave introduction port 10A, between the two sidewall portions 12B and 12D parallel to the long side of the microwave introduction port 10A, another microwave introduction port 10 (microwave introduction port 10C) having a long side in the same direction as the long side of the microwave introduction port 10A is not disposed.

With such an arrangement, it is possible to prevent, as much as possible, the microwaves radiated from the microwave introduction port 10A with a strong directivity in the X-axis direction perpendicular to the long side thereof and the reflected waves thereof from entering another microwave introduction port 10. If there is another microwave introduction port 10 having the long side of the same direction as the microwave introduction port 10A within a range of the length of the long side of the microwave introduction port 10A between the two sidewall portions 12B and 12D parallel to the microwave introduction port 10A, excitation directions of microwaves are the same, and microwaves and reflected waves thereof are likely to enter the microwave introduction port 10 of the same direction, thereby increasing power loss.

On the other hand, if the another microwave introduction port 10 of the same direction as the microwave introduction port 10A is not present between the two parallel sidewall portions 12B and 12D within the range of the length of the long side of the microwave introduction port 10A, the microwaves radiated from the microwave introduction port 10A and the reflected waves thereof are suppressed from entering the other microwave introduction port 10. Therefore, it is possible to suppress the loss of power caused when the microwaves radiated from the microwave introduction port 10A and the reflected waves thereof enter the another microwave introduction port 10.

In FIG. 6, since the microwaves radiated from the microwave introduction port 10A and the reflected waves thereof have an excitation direction different from that of the microwave introduction ports 10B and 10D arranged adjacent to the microwave introduction port 10A to be shifted by 90 degrees, they hardly enter the microwave introduction ports 10B and 10D. Therefore, when the microwave introduction port 10A is translated in the X-axis direction perpendicular to the long side thereof, the microwave introduction port 10A may overlap the microwave introduction ports 10B and 10D having long sides in a direction different from the direction of the long side thereof.

Further, in this embodiment, among the four microwave introduction ports 10 disposed to form a cross shape as a whole, two microwave introduction ports 10 which are not adjacent to each other are arranged such that the central axes AC do not overlap each other on the same straight line. For example, in FIG. 6, the central axis AC of the microwave introduction port 10A and the central axis AC of the microwave introduction port 10C which is not adjacent to the microwave introduction port 10A are disposed in the same direction without overlapping each other. Thus, by arranging two microwave introduction ports 10 which are not adjacent to each other among the four microwave introduction ports 10 such that the central axes AC thereof in the same direction do not overlap each other, it is possible to prevent the microwaves radiated in a direction perpendicular to the short side (Y-axis direction parallel to the long side) of one of two microwave introduction ports 10 having the central axes AC in the same direction, from entering the other, thereby suppressing the loss of power.

In such an arrangement, the central axis AC of each of the microwave introduction ports 10 may not overlap with the center line M. Therefore, each of the microwave introduction ports 10 may be disposed at a position far from the center line M, e.g., at a position at which the long side of each of the microwave introduction ports 10 is close to the sidewall portion 12. From the viewpoint of uniformly introducing microwaves into the processing chamber 2, it is preferable that each of the microwave introduction ports 10 is disposed to be close to the center line M, and it is more preferable that, as shown in FIG. 6, at least a part of each of the microwave introduction ports 10 is disposed so as to overlap the center line M. Further, among the four microwave introduction ports 10 disposed to form a cross shape as a whole, the two microwave introduction ports 10 which are not adjacent to each other may disposed such that the central axes AC overlap each other, and in this case, the central axes AC may coincide with the center line M.

The microwave introduction ports 10A, 10B, 10C and 10D are disposed to establish the above relationship between them and between each of the microwave introduction ports 10 and the sidewall portions 12.

<Modifications>

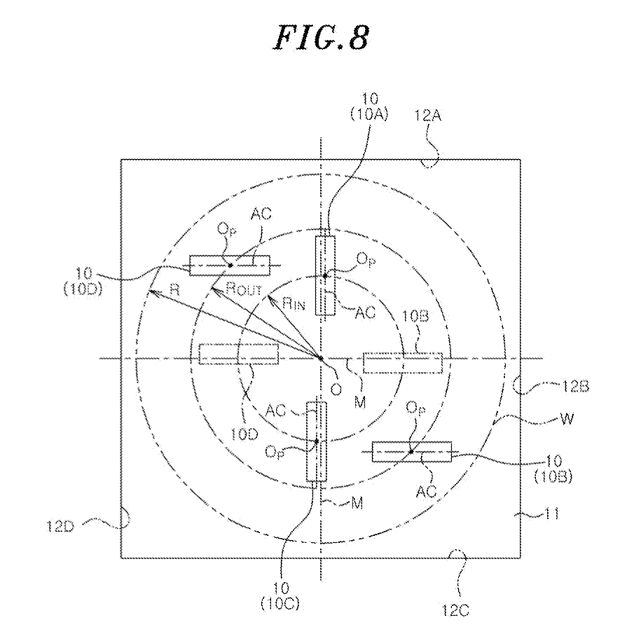

Modifications of the arrangement of the microwave introduction ports 10 will now be described with reference to FIGS. 8 to 10. FIG. 6 shows an exemplary arrangement in which each of the microwave introduction ports 10B and 10D is translated in the Y-axis direction from the reference position. However, for example, as shown in FIG. 8, each of the microwave introduction ports 10B and 10D may be translated in the X-axis direction from the reference position (shown by a dashed double-dotted line in FIG. 8) such that the centers Op thereof overlap with a circumference of a virtual circle having a radius R_{OUT}. Even in this case, similarly to the case of FIG. 6, when the wafer W is rotated horizontally, it is possible to enhance the uniformity of heating in the radial direction of the wafer W in addition to the uniformity of heating in the circumferential direction of the wafer W. Further, although illustration is omitted, each of the microwave introduction ports 10B and 10D may be moved in both the X-axis and Y-axis directions from the reference position such that the centers Oₚ thereof overlap with the circumference of the virtual circle having the radius R_{OUT}.

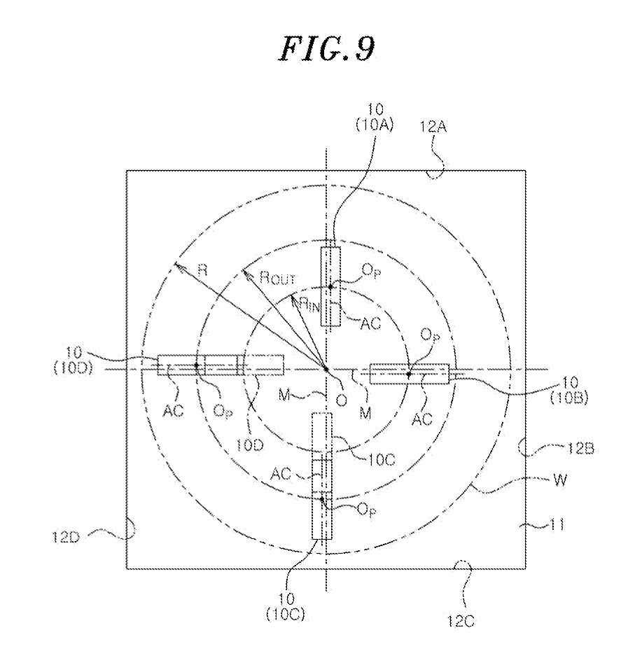

Further, FIGS. 6 and 8 illustrate an arrangement example in which each of the microwave introduction ports 10B and 10D which are not adjacent to each other in the circumferential direction of the wafer W is translated from the reference position. However, the two microwave introduction ports 10 which are adjacent to each other in the circumferential direction of the wafer W may be moved as a group. For example, FIG. 9 is an example in which each of the microwave introduction ports 10C and 10D which are adjacent to each other in the circumferential direction of the wafer W is translated by a distance R_{OUT}-R_{IN} in the Y-axis direction from the reference position (shown by a dashed double-dotted line in FIG. 9) such that the centers Oₚ thereof overlap with the circumference of the virtual circle having the radius R_{OUT}. In this case, similarly to the case of FIG. 6, when the wafer W is rotated horizontally, it is possible to enhance the uniformity of heating in the radial direction of the wafer W in addition to the uniformity of heating in the circumferential direction of the wafer W. Further, also in the present modification, the moving direction of the microwave introduction ports 10 is not limited to the Y-axis direction, and may be the X-axis direction, or both the X-axis and Y-axis directions.

Further, in FIGS. 6 to 9, the four microwave introduction ports 10 are divided into two groups to radiate microwaves into two regions of the inner microwave radiation zone and the outer microwave radiation zone, but the microwave radiation zones are not limited to two inner and outer zones. For example, the four microwave introduction ports 10 may be disposed on four virtual concentric circles with different radii, respectively, such that four microwave radiation zones can be formed. Specifically, for example, as shown in FIG. 10, the four microwave introduction ports 10A to 10D may be arranged on concentric circles which are different in radial distance from the center O of the wafer W (center of the ceiling portion 11).

In the modification shown in FIG. 10, the microwave introduction port 10A is disposed such that the center Oₚ thereof lies on a virtual circle having a radius R₁. The microwave introduction port 10B is disposed such that the center Oₚ thereof lies on a virtual circle having a radius R₂. The microwave introduction port 10C is disposed such that the center Oₚ thereof lies on a virtual circle having a radius R₃. Further, the microwave introduction port 10D is disposed such that the center Oₚ thereof lies on a virtual circle having a radius R₄. Also in this case, similarly to the case of FIG. 6, when the wafer W is rotated horizontally, it is possible to enhance the uniformity of heating in the radial direction of the wafer W in addition to the uniformity of heating in the circumferential direction of the wafer W.

Further, also in the present modification, the moving directions of the microwave introduction ports 10 are not limited to the Y-axis direction, and may be the X-axis direction, or both the X-axis and the Y-axis direction. Furthermore, in FIG. 10, the four microwave introduction ports 10 are arranged such that the positions of the centers Oₚ thereof becomes larger in a radially outward direction clockwise in the order of the microwave introduction ports 10A, 10B, 10C and 10D, but may be arranged randomly, not in this order.

Further, in the example of FIGS. 6 to 10, all of the four microwave introduction ports 10 are disposed immediately above the wafer W to overlap the wafer W. However, as long as uniform heating in the plane of the wafer W is realized, the position of the wafer W and the position of the microwave introduction ports 10 may not necessarily overlap each other.

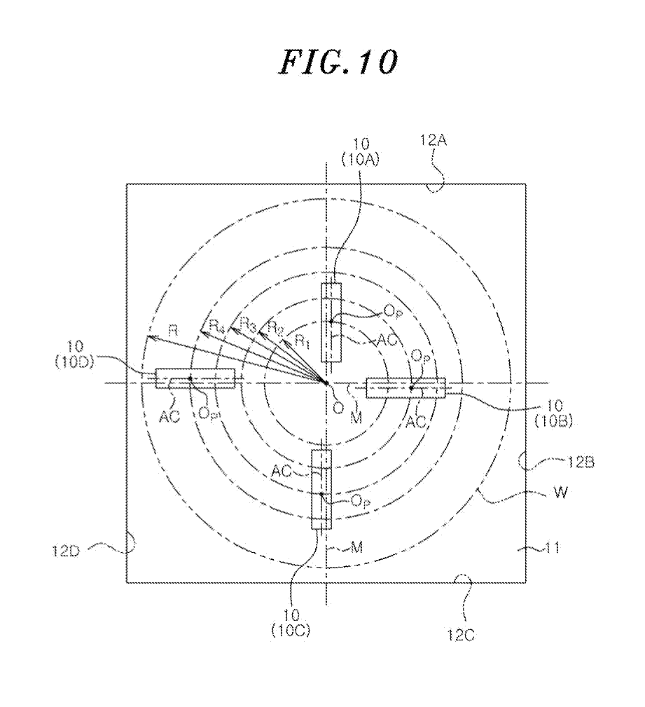

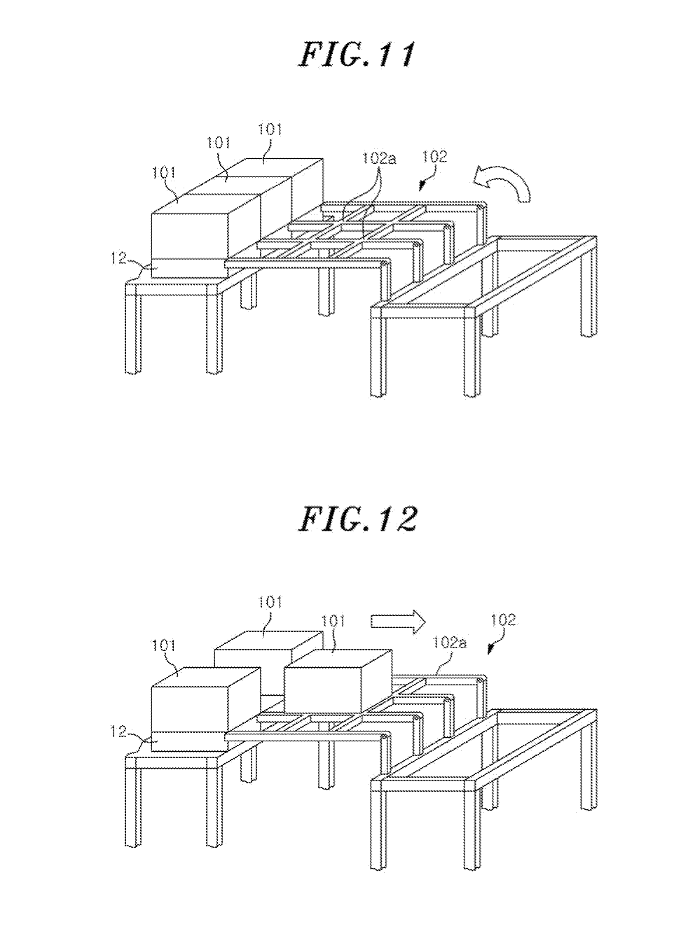

Next, a chamber opening and closing mechanism in the microwave heating apparatus 1 will be described with reference to FIGS. 11 to 13. FIGS. 11 to 13 illustrate a procedure of opening and closing operations of the chamber opening and closing mechanism. Further, in FIGS. 11 to 13, a portion including the ceiling portion 11 of the processing chamber 2 and the microwave introducing device 3 of the microwave heating apparatus 1 is simplified and illustrated in a box shape as an upper unit 101. The chamber opening and closing mechanism of the present embodiment opens the interior of the processing chamber 2 by sliding the upper unit 101 on a rail.

FIG. 11 shows three microwave heating apparatuses 1 and a rail mechanism 102 for pulling out the upper unit 101 in each of the microwave heating apparatuses 1. The rail mechanism 102 has a rail portion 102a in a lattice shape. The rail portion 102a is provided to be foldable such that it is upright when not used, and is developed into a horizontal position to be bridged to the microwave heating apparatus 1 when used.

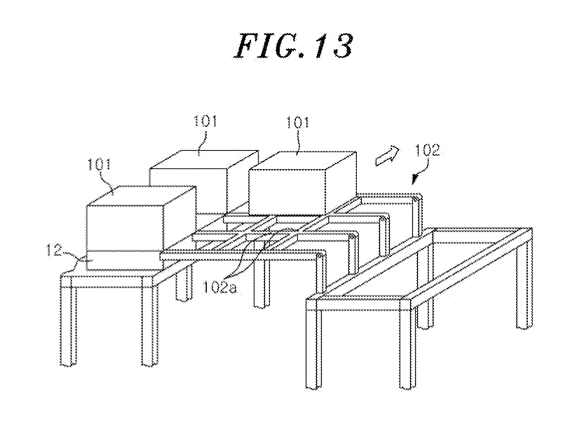

From the state of FIG. 11, the ceiling portion 11, which forms a part of the upper unit 101 and functions as a lid, is pushed up by a lifting force of a lifting unit such as a spring (not shown), and the upper unit 101 is lifted up from the sidewall portions 12 of the processing chamber 2. FIG. 12 shows the state where one of the upper units 101 is pulled out by sliding the upper unit 101 on the rail portion 102a. FIG. 13 shows the state where a sliding direction of the upper unit 101 is changed at a right angle and the upper unit 101 is moved to the front side of the neighboring microwave heating apparatus 1. By providing the rail mechanism 102, it is possible to easily open the processing chamber 2 of the microwave heating apparatus 1, thereby facilitating maintenance of the inside of the processing chamber 2 or the microwave introducing device 3. Further, between a plurality of microwave heating apparatuses 1 sharing the rail mechanism 102, the upper unit 101 can be easily exchanged through the rail mechanism 102.

<Control Unit>

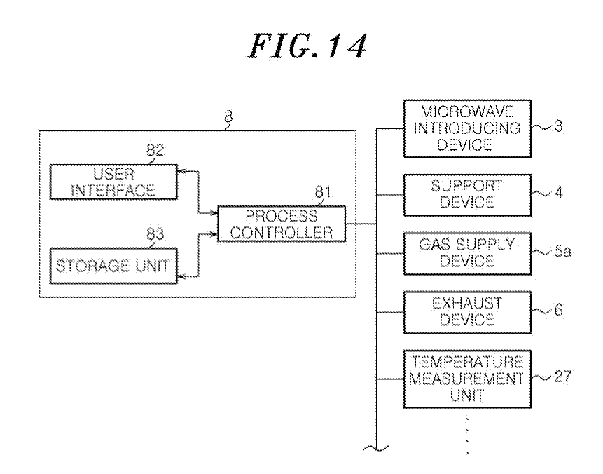

Each component of the microwave heating apparatus 1 is connected to the control unit 8 and controlled by the control unit 8. The control unit 8 is typically a computer. FIG. 14 is a diagram showing a configuration of the control unit 8 shown in FIG. 1. In the example of FIG. 14, the control unit 8 includes a process controller 81 having a CPU, and a user interface 82 and a storage unit 83 connected to the process controller 81.

The process controller 81 is a control means for overall control of respective components (e.g., the microwave introducing device 3, the support device 4, the gas supply device 5a, the exhaust device 6, the temperature measurement unit 27 and the like) involved in the processing conditions such as temperature, pressure, gas flow rate and microwave output in the microwave heating apparatus 1.

The user interface 82 includes a keyboard or touch panel through which a process manager inputs a command to manage the microwave heating apparatus 1, a display for visually displaying an operational status of the microwave heating apparatus 1, and so forth.

The storage unit 63 stores therein, e.g., control programs (software) for implementing various processes in the microwave heating apparatus 1 under the control of the process controller 81, and recipes including processing condition data and the like. In response to instructions from the user interface 82 or the like, if necessary, a control program or recipe is retrieved from the storage unit 83 and executed by the process controller 81. Accordingly, a desired process is performed in the processing chamber 2 of the microwave heating apparatus 1 under the control of the process controller 81.

The control programs and the recipes may be read out from a computer-readable storage medium (e.g., a CD-ROM, a hard disk, a flexible disk, a flash memory, a DVD, a Blu-ray Disc, etc.). Further, the recipes may be used online by transmission from another apparatus through, e.g., a dedicated line, whenever necessary.

[Processing Procedure]

Next, a processing procedure in the microwave heating apparatus 1 when an annealing process is performed on the wafer W will be described. First, a command is inputted to the process controller 81 from, e.g., the user interface 82 to perform an annealing process in the microwave heating apparatus 1. Then, the process controller 81 reads the recipe stored in the storage unit 83 or computer-readable storage medium in response to this command. Then, a control signal is transmitted from the process controller 81 to each end device (e.g., the microwave introducing device 3, the support device 4, the gas supply device 5a, the exhaust device 6, and the like) of the microwave heating apparatus 1 such that the annealing process is performed under the conditions based on the recipe.

Subsequently, the gate valve G is opened, and the wafer W is loaded into the processing chamber 2 through the gate valve G and the loading and unloading port 12a by a transfer device (not shown) and mounted on the support pins 16. The support pins 16 are elevated in a vertical direction together with the shaft 14 and the arm portions 15 by driving the elevation drive unit 18, and the wafer W is set at a predetermined vertical position (initial vertical position). At this vertical position, by driving the rotation drive unit 17, the wafer W is rotated at a predetermined speed in the horizontal direction. Further, the rotation of the wafer W may not be continuous but be discontinuous. Then, the gate valve G is closed, and the processing chamber 2 is vacuum-evacuated by the exhaust device 6 if necessary. Then, the processing gas and the cooling gas are introduced at a predetermined flow rate by the gas supply device 5a. The pressure of the inner space of the processing chamber 2 is adjusted to a predetermined pressure by adjusting the gas supply amount and the exhaust amount.

Then, a voltage is applied from the high voltage power supply unit 40 to each magnetron 31 to generate a microwave.

The microwave generated in the magnetron 31 is propagated through the waveguide 32, and then transmitted through the transmission window 33 to be introduced into a space above the wafer W rotating in the processing chamber 2. In this embodiment, microwaves are generated sequentially in the magnetrons 31, and are alternately introduced into the processing chamber 2 from each of the microwave introduction ports 10. Alternatively, microwaves may be generated simultaneously in the magnetrons 31, and simultaneously introduced into the processing chamber 2 from the microwave introduction ports 10.

The microwaves introduced into the processing chamber 2 are irradiated onto the surface of the rotating wafer W, and the wafer W is heated rapidly by electromagnetic wave heating such as Joule heating, magnetic heating and induction heating. As a result, the annealing process is performed on the wafer W. During the annealing process, the vertical position of the wafer W may be displaced in multiple stages.

For example, during a certain period of time from the start of the annealing process, the wafer W is set at the initial vertical position (first vertical position). Then, by driving the elevation drive unit 18, the wafer W may be moved from the initial vertical position to and set at a second vertical position different from the initial vertical position and the remaining annealing may be carried out at the second vertical position.

Further, the vertical position may be set in three or more stages without being limited to two stages, and switching of the vertical position in two or more stages may be repeated. Thus, by processing the wafer W at the vertical position of two or more stages, it is possible to reduce the bias of the microwaves irradiated to the wafer W and to suppress the reflection of microwaves. As a result, it is possible to make uniform the heating temperature in the plane of the wafer W while improving the heating efficiency by increasing a maximum temperature and a rate of temperature rise.

When a control signal for terminating the annealing process is transmitted from the process controller 81 to each end device of the microwave heating apparatus 1, the generation of the microwaves is stopped, the rotation of the wafer W is stopped, and the supply of the processing gas and the cooling gas is stopped to thereby terminate the annealing process on the wafer W. Then, the gate valve GV is opened, the vertical position of the wafer W on the support pins 16 is adjusted, and the wafer W is unloaded by the transfer device (not shown).

The microwave heating apparatus 1 may be preferably used for the purpose of annealing for activation of doping atoms implanted in a diffusion layer in, e.g., a manufacturing process of semiconductor devices.

Next, effects of the microwave heating apparatus 1 and a processing method of the wafer W using the microwave heating apparatus 1 according to the present embodiment will be described with reference to FIGS. 1, 6 and 15 to 18. In the present embodiment, by driving the rotation drive unit 17, annealing is performed on the wafer W held on the support pins 16 while rotating the wafer W at a predetermined speed in the horizontal direction. Thus, microwave radiation in the circumferential direction within the plane of the wafer W is uniform. Therefore, it is possible to realize uniform annealing in the circumferential direction within the plane of the wafer W by the rotation.

Further, in the present embodiment, in order to achieve uniform microwave irradiation in the radial direction within the plane of the wafer W, as shown in FIG. 6, the four microwave introduction ports 10 may be divided and arranged such that two or more microwave radiation zones can be formed. By this arrangement, in the case of performing annealing on the wafer W while horizontally rotating the wafer W, it is possible to enhance the heating uniformity in the radial direction of the wafer W in addition to the heating uniformity in the circumferential direction of the wafer W. Thus, by combining the rotation of the wafer W and the arrangement of the microwave introduction ports 10, it is possible to realize uniform annealing in the plane of the wafer W.

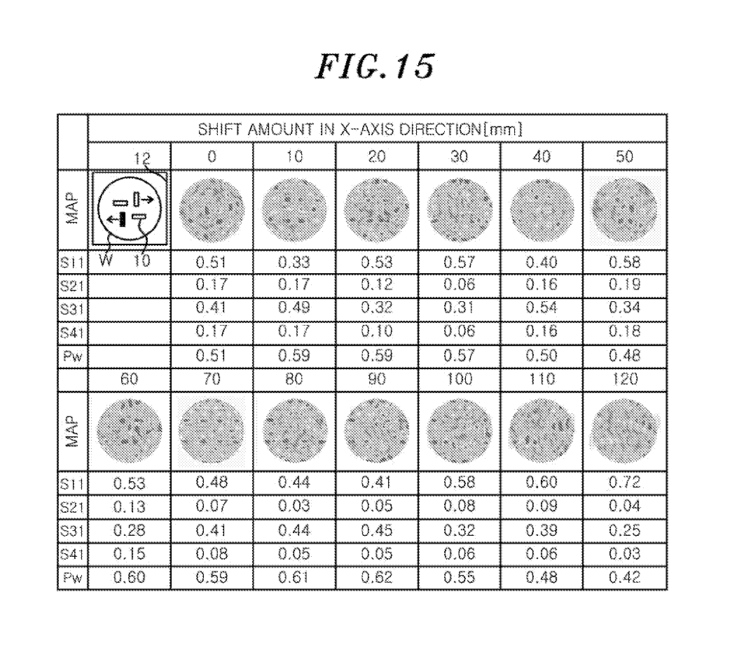

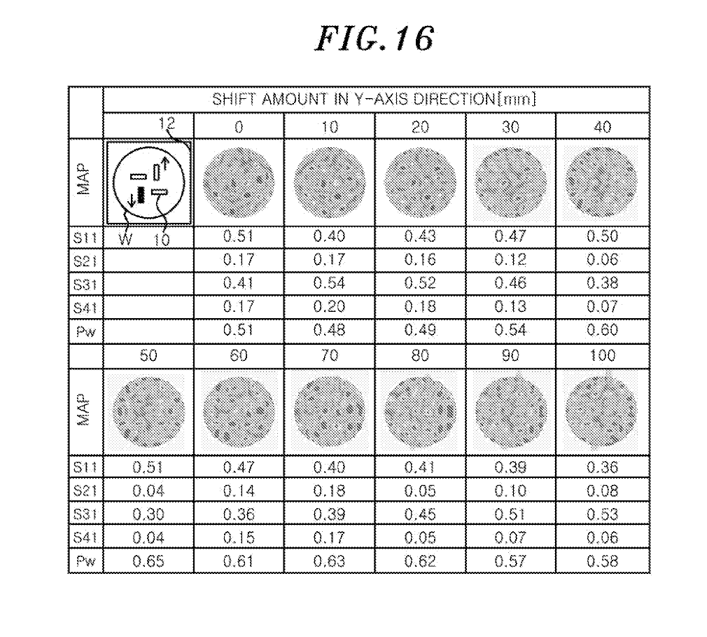

Simulation results of the power absorption efficiency of the wafer W in the case where the arrangement of the microwave introduction ports 10 was changed in the X-axis or the Y-axis direction will now be described with reference to FIGS. 15 and 16. These simulations were carried out for the purpose of obtaining optimal arrangement in the case of forming the inner microwave radiation zone by the two microwave introduction ports 10 located at the reference position among the four microwave introduction ports 10 and forming the outer microwave radiation zone by translating the other two microwave introduction ports 10 in an outward direction.

FIG. 15 and FIG. 16 show maps of simulation results showing volume loss density distribution of microwave power within the plane of the wafer W, and wafer absorbed power Pw and scattering parameters obtained from the simulations. Further, in the frame of the upper left end of FIGS. 15 and 16, the reference positions of the microwave introduction ports 10 simulated and the moving direction therefrom are shown by being projected on the wafer W. In this case, the reference positions of the microwave introduction ports 10 was set as an arrangement in which the center of each of the four microwave introduction ports 10 lies on the virtual circle having a radius of 55 mm from the center O of the wafer W.

FIG. 15 shows the simulation results when the position of the center of each of the two microwave introduction ports 10 which are not adjacent to each other was shifted up to 120 mm by 10 mm increment outwardly in the X-axis direction from the reference position. FIG. 16 shows the simulation results when the position of the center of each of the two microwave introduction ports 10, which are not adjacent to each other, was shifted by 10 mm increment up to 100 mm outwardly in the Y-axis direction from the reference position.

Other conditions in these simulations are as follows. The processing chamber includes the sidewall portions 12 forming a square tubular shape. The long and the short sides of the four microwave introduction ports 10 are provided to be parallel to the inner wall surfaces of the four sidewall portions 12. The ratio L₁/L₂ of the length L₁ of the long sides to the length L₂ of the short sides of the respective microwave introduction port 10 is 4.

Further, the four microwave introduction ports 10 are arranged such that when one of the microwave introduction ports 10 is translated in the X-axis direction perpendicular to the long sides thereof, it does not overlap another microwave introduction port 10 having long sides parallel thereto. The wafer W was assumed to be a silicon wafer doped with impurities such as arsenic. The simulations were conducted under conditions that microwaves of power ranging from 500 W to 3000 W are introduced from one microwave introduction port represented in black in the frame of the upper left end of FIGS. 15 and 16.

In this case, the absorption power of the wafer W can be calculated by using the scattering parameters (S parameters). When the input power is Pin and the total power absorbed by the wafer W is Pw, the total power Pw can be obtained by the following Eq. (1). Further, S11, S21, S31 and S41 are S parameters of the four microwave introduction ports 10, and the microwave introduction port 10 in black corresponds to Port 1.

P_{W}=Pᵢₙ(1−|S11|²−|S21|²−|S31|²−|S41|²) (1)

Further, the distribution of power absorption within the plane of the wafer W was calculated by obtaining the electromagnetic waves volume loss density using a pointing vector in the plane of the wafer W. Further, the total power Pw absorbed by the wafer W can be obtained by the following Eq. (2). By calculating these values with an electromagnetic field simulator and plotting on the wafer W, maps shown in FIGS. 15 and 16 were created. In these maps, although not expressed exactly due to black and white representation, the more light black (white) indicates substantially the larger electromagnetic waves volume loss density within the plane of the wafer W.

P_{W}[W]=∫∫_{SW}Re\vec{S}·\vec{n}dS=∫∫_{SW}∫₀^{δw}Re[1/2(\vec{E}·\vec{J*}−∇×\vec{E}·\vec{H*})]dSdz (2)

In the Eq. (2), \vec{S} is the pointing vector, \vec{J} is a current density, and \vec{E} and \vec{H} represent electric and magnetic field, respectively.

From the simulation results shown in FIG. 15, it is believed that when each of the two microwave introduction ports 10 which are not adjacent to each other is shifted in the X-axis direction from the reference position, the total power Pw absorbed by the wafer W is large at a position to which the corresponding microwave introduction port 10 has been moved by, e.g., 80 mm outwardly, and the power absorption distribution within the plane of the wafer W is also uniform. Thus, this is considered as optimal arrangement for forming the outer microwave radiation zone. Therefore, in the case of the above simulation conditions, it is preferable that each of the two microwave introduction ports 10 which are not adjacent to each other is shifted in the X-axis direction outwardly from the reference position by a distance in the range from 10 mm to 80 mm.

Moreover, from the simulation results shown in FIG. 16, it is thought when each of the two microwave introduction ports 10 which are not adjacent to each other is shifted in the Y-axis direction from the reference position, the total power Pw absorbed by the wafer W is large and the power absorption distribution within the plane of the wafer W is also uniform, at a position to which the corresponding microwave introduction port 10 has been moved by, e.g., 50 mm outwardly. Thus, this is considered as optimal arrangement for forming the outer microwave radiation zone. Therefore, in the case of the above simulation conditions, it is preferable that each of the two microwave introduction ports 10 which are not adjacent to each other is shifted in the Y-axis direction outwardly from the reference position by a distance in the range from 10 mm to 70 mm.

By these simulations, it is possible to determine the optimal positions of the microwave introduction ports 10 for various types of wafers W in the case of rotating the wafer W. Further, it was observed that it is possible to control the distribution of power absorption in the plane of the wafer W by dividing and arranging the four microwave introduction ports 10 to form a plurality of microwave radiation zones.

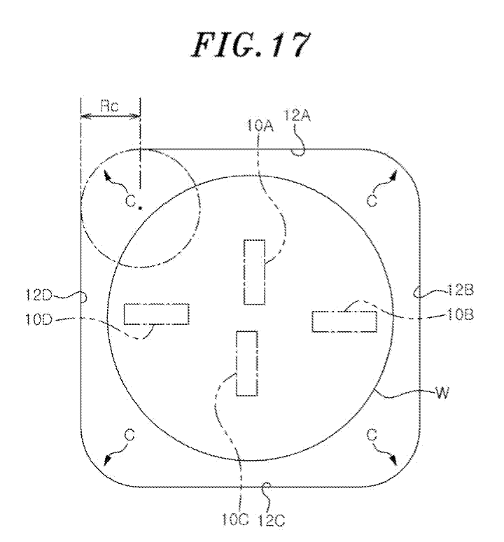

Next, the simulation results obtained by observing an effect of the rounding process of the corner portions as the connecting portions of the adjacent sidewall portions 12 of the processing chamber 2 on the reflection of microwaves will be described with reference to FIGS. 17 and 18. FIG. 17 is an explanatory diagram schematically showing the configuration of the microwave heating apparatus which is assumed in the simulation. FIG. 17 schematically shows a positional relationship of the wafer W and the shape of the sidewall portions 12 (only the positions of the inner wall surfaces are shown) in the case where the rounding process was performed on the corner portions of the connecting portions of the adjacent sidewall portions 12.

Further, in FIG. 17, the positions of the four microwave introduction ports 10A, 10B, 10C and 10D provided in the ceiling portion 11 (not shown) are illustrated by being projected onto the wafer W. As shown in FIG. 17, all corner portions C between the sidewall portion 12A and the sidewall portion 12B, between the sidewall portion 12B and the sidewall portion 12C, between the sidewall portion 12C and the sidewall portion 12D, and between the sidewall portion 12D and the sidewall portion 12A are rounded with a radius of curvature R_{c}. Other configurations were the same as those of the microwave heating apparatus 1.

In the simulation, scattering parameters S11 and S31 when the radius of curvature R_{c} of the rounding process of the corner portions C was changed from 0 mm (right angle) to 18 mm in 1 mm increments ware analyzed. In this case, the microwaves were introduced from the microwave introduction port 10A. S11 is the scattering parameter of the radiated microwaves and the reflected microwaves of the microwave introduction port 10A, and S31 is the scattering parameter of the radiated microwaves of the microwave inlet port 10A and the reflected microwaves of the microwave introduction port 10C.

The simulation results are shown in FIG. 18. It can be seen from FIG. 18 that when the radius of curvature R_{c} ranges from 15 mm to 16 mm, the variation of S11 and S31 is small and each of S11 and S31 has a relatively low value. Therefore, it has been confirmed that, from the viewpoint of suppressing the reflected waves incident onto the microwave introduction ports 10 to increase the use efficiency of the microwave power, in the rounding process of the corner portions C of the connecting portions of the adjacent sidewall portions 12 of the processing chamber 2, the radius of curvature R_{c} preferably ranges from 15 mm to 16 mm. Further, in the simulation, the rounding process was carried out on the corner portions C that is the connecting portions between the adjacent sidewall portions 12 of the processing chamber 2, but the rounding process using the same radius of curvature R_{c} may be preferably applied to the corner portions that is connecting portions between each of the sidewall portions 12 and the bottom portion 13.

From the above simulation results, it was also confirmed that uniform heating processing can be implemented on the wafer W by using the microwave heating apparatus 1 according to the present embodiment.

As described above, in this embodiment, the microwave introduction ports 10 are arranged to correspond to the inner microwave radiation zone and the outer microwave radiation zone in addition to the rotation of the wafer W, thereby improving the in-plane uniformity of the annealing process. However, the microwaves form standing waves, and in the case where the standing waves are generated in the processing chamber 2, positions of nodes and antinodes of the standing waves are fixed. Since the electromagnetic field becomes strong locally at the positions of the nodes of the standing waves, and the electromagnetic field becomes weak locally at the positions of the antinodes of the standing waves, the annealing process may be non-uniform in the radial direction of the wafer W even when the two microwave radiation zones are formed.

Therefore, in the present embodiment, more preferably, it is configured to vary the vertical position of the wafer W by the elevation drive unit 18. As shown in FIG. 1, varying the vertical position of the wafer W supported by the support pins 16 is the same as varying the distance (gap G) from the lower surface of the transmission window 33 of the microwave introduction port 10 to the top surface of the wafer W held on the support pins 16. Even though standing waves are formed in the processing chamber 2, a relative positional relationship between the wafer W and the standing waves can be changed by changing the gap G. As a result, it is possible to change the radiation distribution of microwaves in the radial direction of the wafer W.

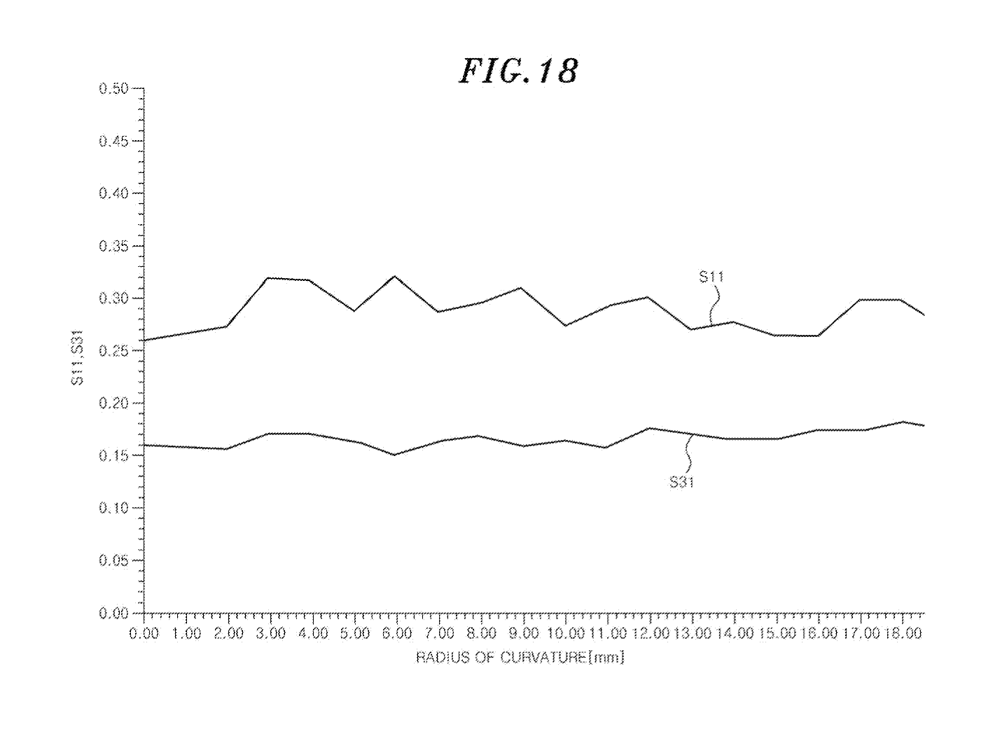

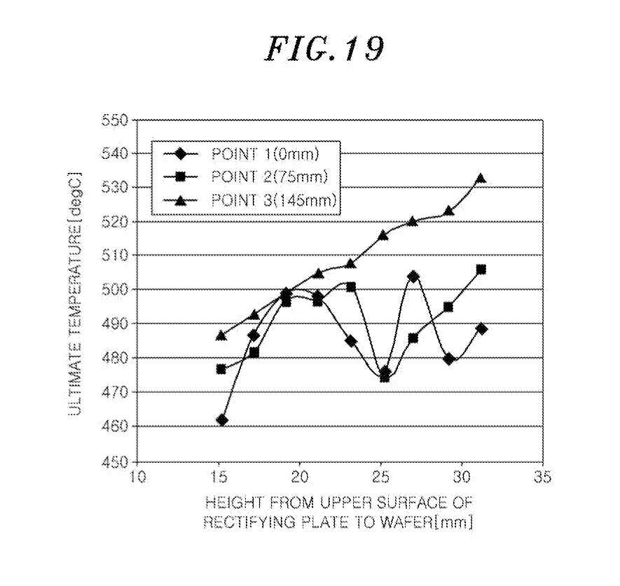

Next, the experimental results in the case where an annealing process was performed while changing the vertical position of the wafer W in the microwave heating apparatus 1 will be described with reference to FIGS. 19 to 26.

### EXPERIMENTAL EXAMPLE 1

FIG. 19 is a graph showing the results of an experiment of measuring a temperature change in the plane of the wafer W when an annealing process was performed while changing the vertical position of the wafer W having a diameter of 300 mm, which is supported on the support pins 16, by using the microwave heating apparatus 1. In this experiment, three points of point 1 (0 mm in the radial direction from the center O of the wafer W), point 2 (75 mm in the radial direction from the center O of the wafer W), and point 3 (145 mm in the radial direction from the center O of the wafer W) were measured.

The annealing process was carried out for 5 minutes at a microwave frequency of 5.8 GHz, a microwave power of 2000 W, a pressure of 90 kPa, and a nitrogen gas flow rate of 10 slm (L/min). The horizontal axis of FIG. 19 shows the vertical position of the wafer W, which is a height (mm) from the upper surface of the rectifying plate 24. Further, the height from the upper surface of the rectifying plate 24 to the lower surface of the transmission window 33 covering the microwave introduction port 10 is 67 mm. The vertical axis of FIG. 19 is an attainment temperature at each measuring point of the wafer W.

It can be found from FIG. 19 that a change in the heating temperature depending on the vertical position of the wafer W is largely different between the points 1, 2 and 3. For example, temperature differences between three measuring points in the plane of the wafer W range from 2° C. to 3° C. if the height from the upper surface of the rectifying plate 24 is about 20 mm, whereas they are increased to about 40° C. if the height from the upper surface of the rectifying plate 24 is about 30 mm. This indicates that the temperature distribution within the plane of the wafer W varies according to the vertical position of the wafer W, and the temperature distribution within the plane of the wafer W can be controlled by changing the vertical position of the wafer W.

### EXPERIMENTAL EXAMPLE 2

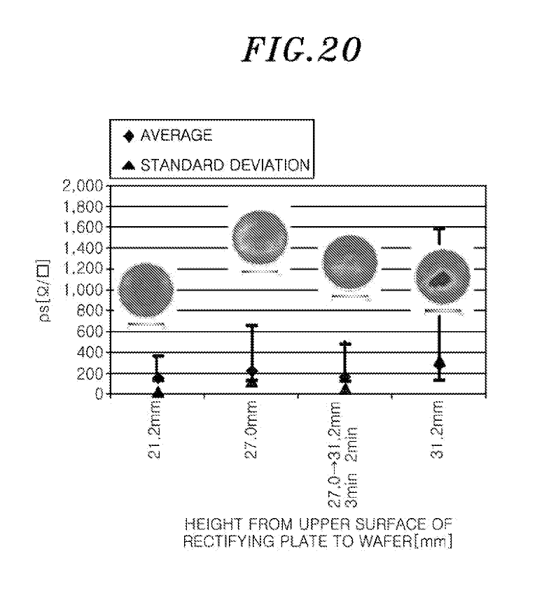

FIG. 20 is a graph showing measurement results of a sheet resistance value when a silicon wafer doped with arsenic as impurities was annealed and activated by performing an annealing process while changing the vertical position of the wafer in the microwave heating apparatus 1. The annealing conditions were the same as those in Experiment 1. FIG. 20 shows an average and a standard deviation of a sheet resistance (ρs) for the cases where the vertical position of the wafer W was set to 21.2 mm, 27.0 mm and 31.2 mm from the upper surface of the rectifying plate 24, and for the case where processing for 3 minutes at the vertical position of 27.0 mm is combined with processing for 2 minutes at the vertical position of 31.2 mm. FIG. 20 also shows a map indicating in-plane distribution of the wafer W of the sheet resistance at each vertical position. These maps are black-and-white displays and do not exactly represent the in-plane distribution of the sheet resistance, but they show that the distribution of the sheet resistance is smaller (uniformity is better) as shading of the color is less.

It can be confirmed from FIG. 20 that in the cases where the vertical position of the wafer W is 27.0 mm and 31.2 mm from the upper surface of the rectifying plate 24, the standard deviations of the sheet resistance values are large and the map showing the in-plane distribution of the sheet resistance also has a large variation. On the other hand, it can be confirmed that in the case where the vertical position of the wafer W is 21.2 mm from the upper surface of the rectifying plate 24, the standard deviation of the sheet resistance value is small, and the map showing the in-plane distribution of the sheet resistance has a substantially uniform state.

Referring to the results of Experiment 1 shown in FIG. 19, the temperature distribution within the plane of the wafer W is the smallest when the vertical position of the wafer W is about 20 mm from the upper surface of the rectifying plate 24, which is consistent with that shown in FIG. 20, that is, the in-plane uniformity of the sheet resistance is high when the vertical position of the wafer W is 21.2 mm from the upper surface of the rectifying plate 24. On the other hand, as shown in FIG. 19, the temperature differences in the plane of the wafer W are largest when the vertical position of the wafer W is about 30 mm from the upper surface of the rectifying plate 24, which is consistent with that shown in FIG. 20, i.e., the variations of the sheet resistance values are high when the vertical position of the wafer W is 27.0 mm and 31.2 mm from the upper surface of the rectifying plate 24.

Further, in the case of changing the vertical position of the wafer W from 27.0 mm (for 3 min) to 31.2 mm (for 2 min) during the annealing process, the uniformity of the sheet resistance within the plane of the wafer W is significantly improved as compared to the case where the vertical position is 27.0 mm or 31.2 mm. It is considered that this is because the non-uniformity of the annealing process at each vertical position is offset and the distribution of the sheet resistance within the plane of the wafer W is resolved as a result of combining two different vertical positions.

### EXPERIMENTAL EXAMPLE 3

A microwave reflection amount and a temperature change in the plane of the wafer W when an annealing process was performed while changing the vertical position of the wafer W having a diameter of 300 mm, which is supported by the support pins 16 in the microwave heating apparatus 1 were measured. The microwave reflection amount was measured by the detector 35 (hereinafter, the same applies). In this experiment, the annealing process was carried out for 2 minutes at a microwave frequency of 5.8 GHz, microwave power of 3900 W, a pressure of 100 kPa, and a nitrogen gas flow rate of 5 slm (L/min).

The experiment was performed by changing a height (hereinafter, may be referred to as “wafer height”) Z to the back surface of the wafer W from the upper surface of the bottom portion 13 of the processing chamber 2. The height Z was set to 34 mm under condition A, the height Z was set to 36 mm under condition B, and the height Z was changed from 34 mm to 36 mm during the annealing process under condition C. A timing of changing the wafer height Z under condition C was set to a time point when about 25 seconds have been elapsed from the start of the annealing process.

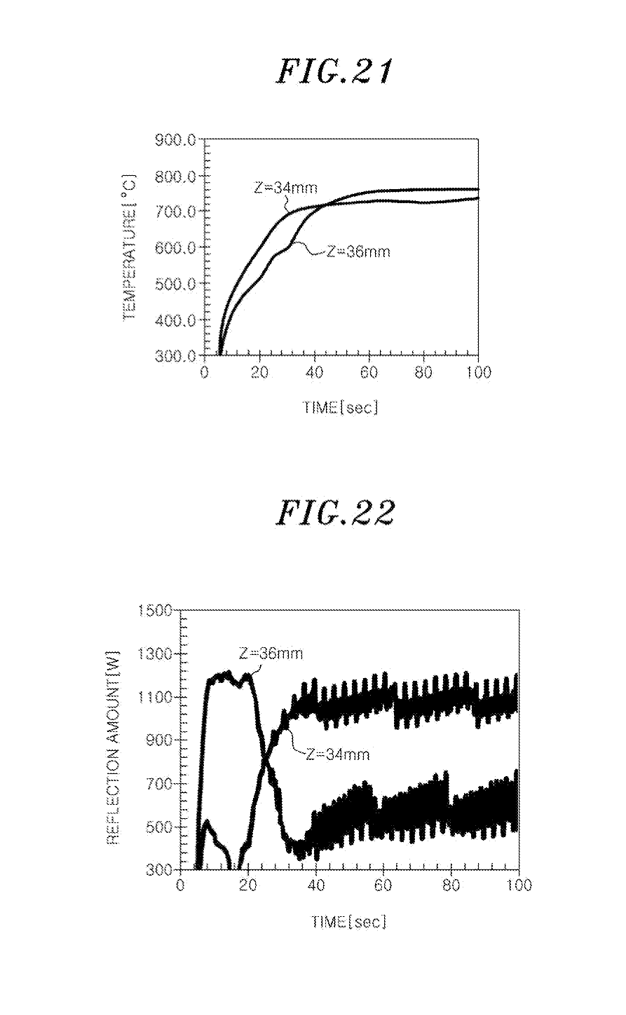

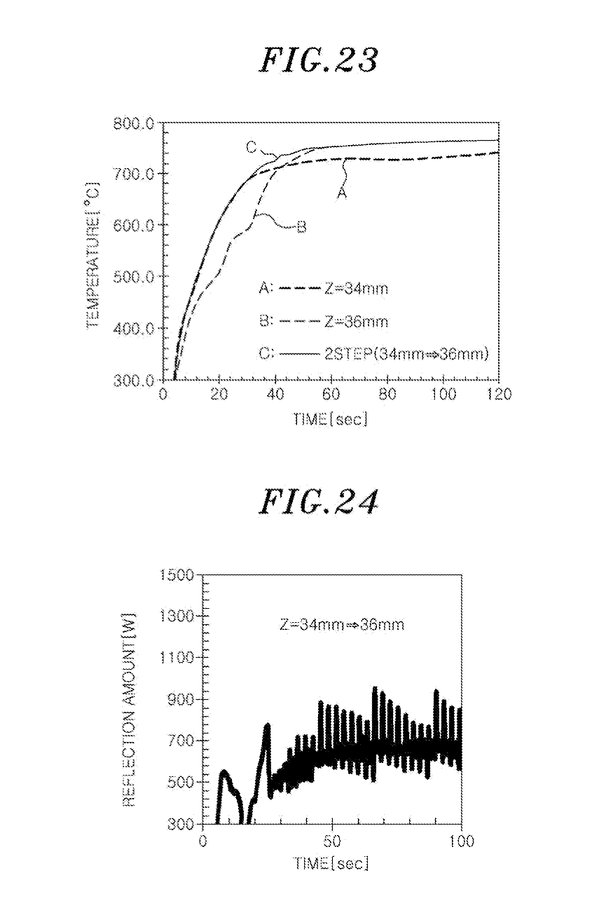

In the annealing process under condition A and condition B, a relationship between time and the temperature of the wafer W is shown in FIG. 21, and a relationship between time and the microwave reflection amount is shown in FIG. 22. Further, under condition C, a relationship between time and the temperature of the wafer W is shown in FIG. 23, and a relationship between time and the microwave reflection amount is shown in FIG. 24. Further, for reference, FIG. 23 also shows the results of condition A and condition B together with the result of condition C.

It can be seen from FIGS. 21 and 23 that the temperature rise rate under condition A (Z=34 mm) is higher than that under condition B (Z=36 mm), and the maximum attainment temperature under condition B is higher than that under condition A. Further, the temperature rise rate under condition C (Z=34 mm [symbol] 36 mm) is the same as that under condition A, and the maximum temperature under condition C is the same as that under condition B. That is, by changing the wafer height Z from 34 mm to 36 mm during the annealing process, under condition C, both a large temperature rise rate equivalent to that under condition A and a high attainment temperature equivalent to that under condition B are obtained.

In addition, it can be seen from FIG. 22 that in the case of condition B (Z=36 mm), the microwave reflection amount is large until the processing time reaches about 30 seconds as compared to condition A (Z=34 mm). On the other hand, under condition A (Z=34 mm), the reflection amount is increased from when the processing time exceeds about 30 seconds. It is considered that this is because the matching in the processing chamber 2 was changed by the temperature rise of the wafer W. However, it can be seen from FIG. 24 that under condition C that the wafer height Z is changed during the annealing process, it is possible to reduce the microwave reflection amount.

### EXPERIMENTAL EXAMPLE 4

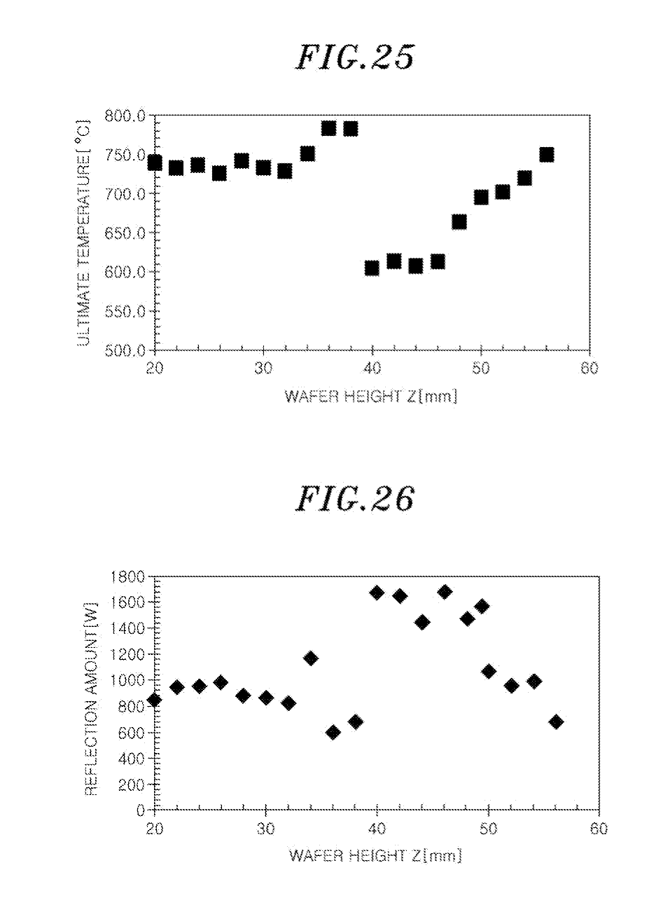

FIG. 25 is a graph showing the results of an experiment of measuring the maximum temperature of the wafer W when an annealing process was performed while changing the vertical position of the wafer W having a diameter of 300 mm, which is supported by the support pins 16, by using the microwave heating apparatus 1. The experiment was performed by changing the wafer height Z. The annealing process was carried out for 5 minutes at a microwave frequency of 5.8 GHz, a microwave power of 3900 W, a pressure of 100 kPa, and a nitrogen gas flow rate of 5 slm (L/min). It was confirmed from FIG. 25 that by changing the wafer height Z, the heating temperature (maximum temperature) of the wafer W is also changed and, thus, the wafer height Z affects the heating efficiency.

### EXPERIMENTAL EXAMPLE 5

FIG. 26 is a graph showing the results of an experiment of measuring the microwave reflection amount when an annealing process was performed while changing the vertical position of the wafer W having a diameter of 300 mm, which is supported by the support pins 16, under the same conditions as Experiment 4 by using the microwave heating apparatus 1. It was confirmed from FIG. 26 that by changing the wafer height Z, the microwave reflection amount is changed and, thus, the wafer height Z affects the absorption efficiency of microwaves.

From the above results, it became clear that the vertical position of the wafer W may significantly affect the microwave reflection amount in the annealing process, the temperature distribution in the plane of the wafer W, the distribution of the sheet resistance, the temperature rise rate and the maximum temperature. Further, it was confirmed that by changing the vertical position of the wafer W during the annealing process, it is possible to make uniform the sheet resistance or temperature distribution in the plane of the wafer W, and also improve the heating efficiency by suppressing the reflection of microwaves to increase the temperature rise rate and the maximum temperature.

As described above, in the microwave heating apparatus and the processing method according to the present embodiment, by performing the annealing process while rotating the wafer W at a predetermined speed in the horizontal direction, the radiation of microwaves in the circumferential direction of the wafer W is made uniform. Further, by arranging the four microwave introduction ports 10 such that the centers Oₚ thereof lie on two virtual concentric circles and two microwave radiation zones are formed, when the annealing process is performed while horizontally rotating the wafer W, it is possible to enhance the heating uniformity in the radial direction of the wafer W in addition to the heating uniformity in the circumferential direction of the wafer W. Further, in the microwave heating apparatus and the processing method according to the present embodiment, by changing the vertical position of the wafer W during the annealing process, it is possible to further improve the in-plane uniformity of the annealing process on the wafer W. Thus, according to the microwave heating apparatus and the processing method of the present embodiment, it is possible to perform uniform heating processing on the wafer W.

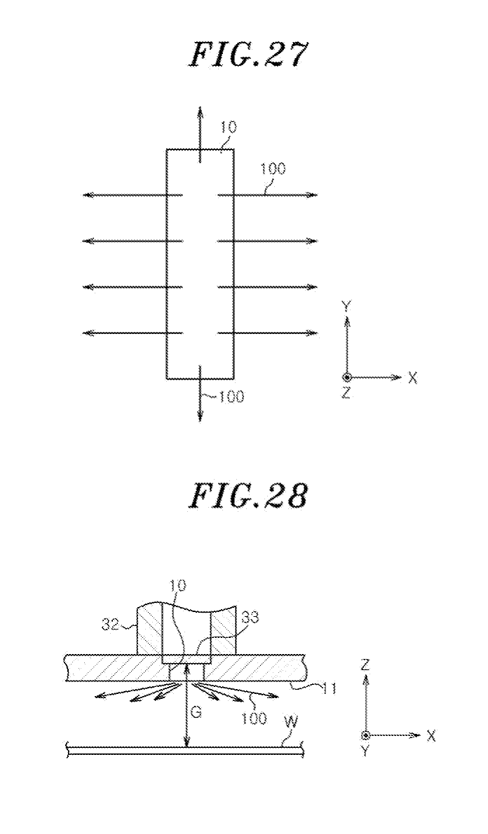

Next, other effects of the microwave heating apparatus 1 according to the present embodiment will be described. In this embodiment, by combination of the characteristic arrangement and the characteristic shape of the microwave introduction ports 10 and the shape of the sidewall portions 12 of the processing chamber 2, the microwaves radiated from one microwave introduction port 10 into the processing chamber 2 are prevented as much as possible from entering the other microwave introduction ports 10. FIGS. 27 and 28 schematically show the radiation directivity of the microwaves in the microwave introduction port 10, a ratio L₁/L₂ of the length L₁ of the long sides to the length L₂ of the short sides of which is at least 4. FIG. 27 shows the microwave introduction port 10 viewed from below the ceiling portion 11 (not shown). FIG. 28 shows the microwave introduction port 10 in a cross-section of the ceiling portion 11 in a direction of the short side thereof.

In FIGS. 27 and 28, arrows indicate electromagnetic field vectors 100 radiated from the microwave introduction port 10, and the directivity of the microwaves is stronger as the arrow is longer. Further, in FIGS. 27 and 28, both the X axis and the Y axis are oriented in the direction parallel to the lower surface of the ceiling portion 11. The X axis refers to a direction perpendicular to the long sides of the microwave introduction port 10, and the Y axis refers to a direction parallel to the long sides of the microwave introduction port 10. Further, the Z axis refers to a direction perpendicular to the lower surface of the ceiling portion 11.

In this embodiment, as described above, the four microwave introduction ports 10 formed in a rectangular shape having long and short sides in a plan view are arranged in the ceiling portion 11. The ratio L₁/L₂ of the microwave introduction port 10 used in this embodiment is set to, e.g., 2 or more, preferably, 4 or more. Therefore, as shown in FIG. 27, the radiation directivity of the microwaves is strong and becomes dominant along the X axis (direction perpendicular to the long sides (direction parallel to the short sides)). Accordingly, the microwaves radiated from any one of the microwave introduction ports 10 mainly propagate along the ceiling portion 11 of the processing chamber 2, and are reflected by the inner wall surfaces of the sidewall portions 12 serving as reflective surfaces, which are parallel to the long sides thereof.

In this embodiment, the inner wall surfaces of the four sidewall portions 12 of the processing chamber 2 are provided in a direction perpendicular to each other, and the long sides and the short sides of each of the four microwave introduction ports 10 are provided to be parallel to the inner wall surfaces of the four sidewall portions 12A, 12B, 12C and 12D. Therefore, the direction of the waves reflected by the four sidewall portions 12A, 12B, 12C and 12D is opposite by almost 180 degrees to the direction of traveling waves, and the reflected waves hardly travel toward the other microwave introduction ports 10.

In the present embodiment, by setting the ratio L₁/L₂ to 2 or more, preferably, 4 or more, as shown in FIG. 28, the directivity of the microwaves radiated from the microwave introduction ports 10 increases in the lateral direction (X-axis direction), and propagates mainly in the lateral direction along the lower surface of the ceiling portion 11. Therefore, the amount of microwaves irradiated directly onto the wafer W located immediately below the microwave introduction ports 10 is small, and local heating does not easily occur even when the gap G is reduced by increasing the vertical position of the wafer W. As a result, it is possible to perform uniform processing on the wafer W in the microwave heating apparatus 1 according to the present embodiment.

On the other hand, if the ratio L₁/L₂ is smaller than 2, although not shown, since the directivity of the microwaves becomes stronger along the Y axis, i.e., in the direction parallel to the long sides (direction perpendicular to the short sides) and the directivity in the X-axis direction perpendicular to the long sides (direction parallel to the short sides) is relatively weakened, a dominant direction in the radiation directivities of the microwaves disappears.

Thus, when the microwave introduction ports 10 having the ratio L₁/L₂ smaller than 2 (e.g., long side:short side=1:1) are arranged as shown in FIG. 6, for example, the microwaves radiated from the microwave introduction port 10A are likely to propagate also in the direction (Y-axis direction) parallel to the long sides of the microwave introduction port 10A and enter the microwave introduction port 10C. Further, in the microwave introduction port 10 having the ratio L₁/L₂ less than 2, the directivity of the radiated microwaves becomes strong in a downward direction (i.e., direction toward the wafer W along the Z axis), and a percentage of the microwaves irradiated directly onto the wafer W immediately below the microwave introduction port 10 increases. Accordingly, local heating in the plane of the wafer W is likely to occur in the case of reducing the gap G by increasing the vertical position of the wafer W.

In the present embodiment, as shown in FIG. 6, the four microwave introduction ports 10 having the ratio L₁/L₂ of 2 or more are arranged to be shifted by an angle of 90 degrees such that central axes AC parallel to the long sides of the two microwave introduction ports 10 adjacent to each other are perpendicular to each other. Further, each microwave introduction port 10 is disposed so as not to overlap the other microwave introduction port 10 having long sides parallel thereto when it is translated in the direction perpendicular to the long sides. Thus, it is possible to prevent the microwaves radiated from one of the microwave introduction ports 10 and the reflected waves thereof from entering the other microwave introduction port 10 having the same microwaves excitation direction as that of the one microwave introduction port 10 in the direction perpendicular to the long sides of the one microwave introduction port 10.

Further, in this embodiment, the two microwave introduction ports 10 which are not adjacent to each other among the four microwave introduction ports 10 are arranged such that the central axes AC thereof do not overlap each other on the same straight line. With this arrangement, also in the direction perpendicular to the short sides of the microwave introduction ports 10, the microwaves radiated from one of the microwave introduction ports 10 and the reflected waves thereof hardly enter the other microwave introduction port 10 having the same microwaves excitation direction as that of the one microwave introduction port 10.

As the above, in the present embodiment, the microwave introduction ports 10 are arranged in consideration of the shape of the microwave introduction ports 10, particularly, the ratio L₁/L₂, the radiation directivity of the microwaves which depends on the shape of the microwave introduction ports 10, and the shape of the sidewall portions 12 of the processing chamber 2. Therefore, in this embodiment, it is possible to prevent as much as possible the microwaves introduced from one of the microwave introduction ports 10 from entering the other microwave introduction ports 10, thereby minimizing the loss of power.

In the microwave heating apparatus 1 of the present embodiment, as described above, the characteristic arrangement and the characteristic shape of the microwave introduction ports 10 and the shape of the sidewall portions 12 of the processing chamber 2 are combined with the rotation of the wafer W and the adjustment of the vertical position. By efficiently using the microwaves having the radiation directivity shown in FIGS. 27 and 28 or the reflected waves traveling in the opposite direction thereto through this combination, it is possible to perform the annealing process with excellent uniformity in the radial direction as well as in the circumferential direction in the plane of the wafer W.

### Second Embodiment

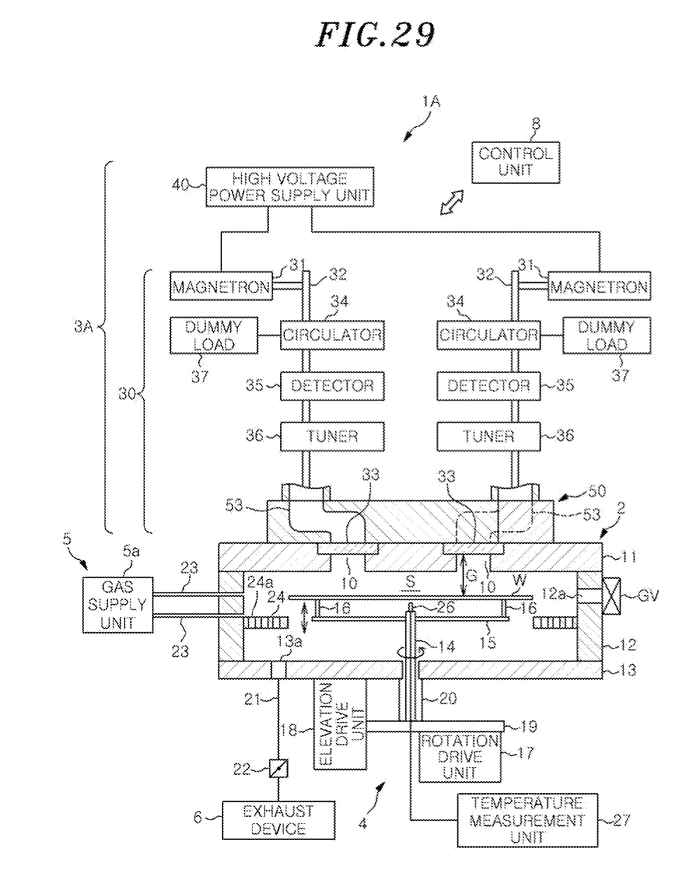

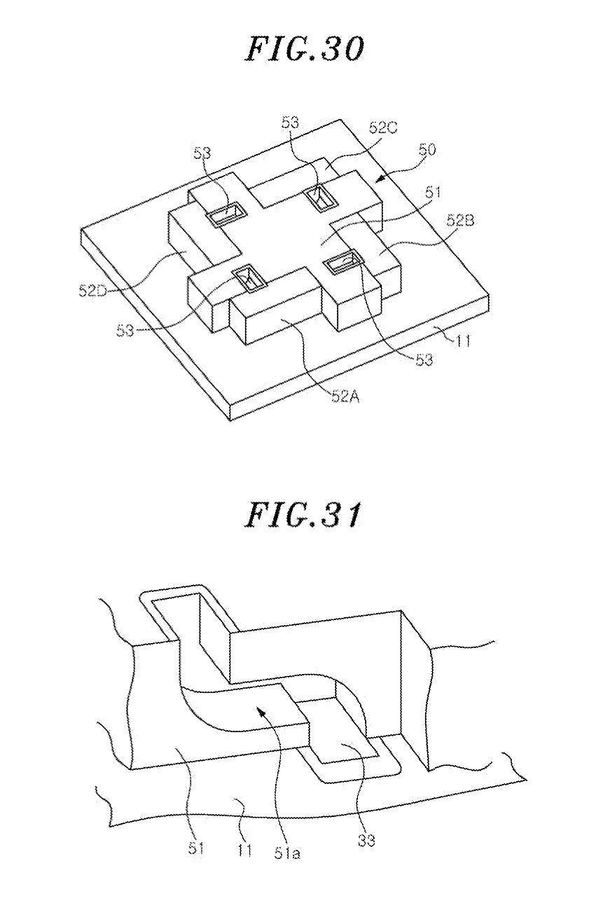

Next, a microwave heating apparatus according to a second embodiment of the present invention will be described with reference to FIGS. 29 to 31. FIG. 29 is a cross-sectional view showing a schematic configuration of a microwave heating apparatus 1A according to the present embodiment. FIG. 30 is an explanatory diagram showing a state in which a microwave introducing adaptor 50 serving as an adaptor member having a waveguide path for transmitting microwaves therein is mounted on the ceiling portion 11 in the microwave heating apparatus 1A. FIG. 31 is an explanatory diagram showing a state of a groove formed in the microwave introducing adaptor 50.

The microwave heating apparatus 1A of the present embodiment performs an annealing process by irradiating microwaves to, e.g., a semiconductor wafer W for manufacturing semiconductor devices in accordance with a plurality of consecutive operations. In the following description, differences between the microwave heating apparatus 1B of the present embodiment and the microwave heating apparatus 1 of the first embodiment will be mainly described. In the microwave heating apparatus 1A shown in FIGS. 29 to 31, components having the same configuration as those in the microwave heating apparatus 1 of the first embodiment are denoted by the same reference numerals, and a description thereof will be omitted.

The microwave heating apparatus 1A includes a processing chamber 2 for accommodating a wafer W serving as a target object to be processed, a microwave introducing device 3A for introducing microwaves into the processing chamber 2, a support device 4 for supporting the wafer W in the processing chamber 2, a gas supply mechanism 5 for supplying a gas into the processing chamber 2, an exhaust device 6 for vacuum-evacuating the processing chamber 2, and a control unit 8 for controlling the respective components of the microwave heating apparatus 1A.

The microwave introducing device 3A is provided at the top of the processing chamber 2, and functions as a microwave introducing unit for introducing electromagnetic waves (microwaves) into the processing chamber 2. As shown in FIG. 29, the microwave introducing unit 3A includes a plurality of microwave units 30 for introducing the microwaves into the processing chamber 2, a high voltage power supply unit 40 connected to the microwave units 30, and the microwave introducing adaptor 50 connected between a waveguide 32 and microwave introduction ports 10 to transmit the microwaves therebetween.

In the present embodiment, the microwave units 30 have the same configuration. Each of the microwave units 30 includes a magnetron 31 to generate microwaves for processing the wafer W, the waveguide 32 to transmit the microwaves generated in the magnetron 31 to the processing chamber 2, and a transmission window 33 fixed to the ceiling portion 11 to cover the microwave introduction port 10. Each of the microwave units 30 further includes a circulator 34, a detector 35 and a tuner 36 which are provided in the waveguide 32, and a dummy load 37 connected to the circulator 34.

As shown in FIG. 30, the microwave introducing adaptor 50 includes a plurality of metallic block bodies. That is, the microwave introducing adaptor 50 includes a single large central block 51 disposed at the center thereof, and four auxiliary blocks 52A, 52B, 52C and 52D disposed around the central block 51. The block bodies are fixed to the ceiling portion 11 by a fixing unit such as a bolt.

As shown in FIG. 31, the central block 51 has a plurality of grooves 51a formed on its side surfaces. At the corresponding side of the central block 51, each of the grooves 51a is formed to have a substantially S-shape extending from the upper surface to the lower surface of the central block 51 in a side view. The number of the grooves 51a corresponds to the number of the microwave units 30, and is four in this embodiment.

The auxiliary blocks 52A to 52D are combined with the central block 51 to form the microwave introducing adaptor 50. The auxiliary blocks 52A to 52D are arranged respectively to correspond to the grooves 51a of the central block 51. That is, each of the auxiliary blocks 52A to 52D is fixed in close contact with the side surface on which each of the grooves 51a of the central block 51 is formed. Further, a substantially S-shaped waveguide path 53 capable of transmitting microwaves therethrough is formed by closing an opening of the groove 51a on the side surface of the central block 51 by each of the auxiliary blocks 52A to 52D. That is, the waveguide path 53 is formed by three walls in the groove 51a and one wall of each of the auxiliary blocks 52A to 52D.

The waveguide path 53 is a through opening extending from the upper surface to the lower surface of the microwave introducing adaptor 50. The upper end of the waveguide path 53 is fixed to the lower end of the waveguide 32, and the lower end of the waveguide path 53 is connected to the transmitting window 33 for closing the microwave introduction port 10. The waveguide 32 is position-aligned with the waveguide path 53 and fixed to the microwave introducing adaptor 50 by a fixing unit such as a bolt. The waveguide path 53 is formed in an S shape in order to shift the positions of the waveguide 32 and the microwave introduction port 10 in the horizontal direction while minimizing the transmission loss of the microwaves. Thus, by using the combination of a plurality of block bodies, it is possible to form the waveguide path 53 with little transmission loss by simple metal processing.

In the microwave heating apparatus 1A of the present embodiment, by using the microwave introducing adaptor 50, it is possible to significantly increase the flexibility of arrangement of the microwave units 30 and the microwave introduction ports 10. In the microwave heating apparatus 1A, it is necessary to provide the components of the four microwave units 30 except for the transmission windows 33 at the top of the processing chamber 2. However, since there is a limit to an installation space above the processing chamber 2, in the configuration in which the waveguides 32 are connected directly to the microwave introduction ports 10, the arrangement of the microwave introduction ports 10 may be restricted by the interference between the adjacent microwave units 30.

In the present embodiment, the relative position between the microwave introduction port 10 and the waveguide 32 may be flexibly adjusted by using microwave introducing adaptor 50 having the S-shaped waveguide path 53. That is, it is possible to flexibly adjust from the fixed arrangement in which they overlap each other vertically to the arrangement in which they do not overlap each other vertically or they only partially overlap each other (i.e., to be shifted laterally). Thus, by using the microwave introducing adaptor 50, the microwave introduction port 10 may be provided at any portion of the ceiling portion 11 without being restricted to the installation space of the microwave unit 30. For example, in the case where the four microwave introduction ports 10 are arranged to be concentrated near the center of the ceiling portion 11, it is possible to avoid the interference between the microwave units 30 by using the microwave introducing adaptor 50.

In the microwave heating apparatus 1A as described above, by using the microwave introducing adaptor 50, the flexibility of arrangement of the microwave introduction ports 10 is significantly improved. Therefore, according to the microwave heating apparatus 1A of the present embodiment, the uniformity of heating in the plane of the wafer W may be improved to perform uniform heating processing on the wafer W.

The other configurations and effects of the microwave heating apparatus 1A of the present embodiment are the same as those of the microwave heating apparatus 1 of the first embodiment, and a description thereof will be omitted. Further, the block body used in the microwave introducing adaptor 50 may have various shapes and sizes according to the number and arrangement of the microwave introduction ports 10. For example, the waveguide path may be formed by combining small block bodies such as the auxiliary blocks 52A to 52D without providing the central block 51. Further, in this embodiment, the microwave introducing adaptor 50 is common to the microwave units 30, but the microwave introducing adaptor 50 may be provided individually for each of the microwave units 30. Further, the microwave introducing adaptor 50 may be included as a part of the configuration of the microwave unit 30.

The present invention may be modified in various ways without being limited to the above embodiments. For example, the microwave heating apparatus of the present invention is not limited to the case of using a semiconductor wafer as a target object to be processed and may also be applied to a microwave heating apparatus which uses, as the target object, e.g., a substrate for a solar cell panel or a substrate for a flat panel display.

The number of the microwave units 30 (the magnetrons 31) and the number of microwaves simultaneously introduced into the processing chamber 2 are not limited to those described in the above embodiments.

This international application claims priority to Japanese Patent Application No. 2012-40095 filed on Feb. 27, 2012, Japanese Patent Application No. 2012-179803 filed on Aug. 14, 2012, and Japanese Patent Application No. 2012-261338 filed on Nov. 29, 2012, the entire contents of which are incorporated herein by reference.

What is claimed is:

1. A microwave heating apparatus comprising:
a processing chamber configured to accommodate a target object to be processed, the processing chamber including a microwave irradiation space;
a support device configured to support the target object in the processing chamber; and
a microwave introducing device configured to generate microwaves for heating the target object and introduce the microwaves into the processing chamber,
wherein the processing chamber further includes a top wall, a bottom wall, and four sidewalls connected to each other,
wherein the top wall has a plurality of microwave introduction ports through which the microwaves generated in the microwave introducing device are introduced into the processing chamber,
wherein each of the microwave introduction ports is formed in a rectangular shape having long sides and short sides in a plan view, the long sides and the short sides being parallel to inner wall surfaces of the four sidewalls, and
wherein the support device includes a support member in contact with the target object to support the target object, and a rotating mechanism for rotating the target object supported by the support member.

2. The microwave heating apparatus of claim 1, wherein the support device further includes a vertical position adjusting mechanism for adjusting a vertical position of the target object supported by the support member.

3. The microwave heating apparatus of claim 1, wherein the microwave introduction ports include a first to a fourth microwave introduction port, and the first to the fourth microwave introduction port are divided into two microwave introduction ports corresponding to an inner microwave radiation zone and two microwave introduction ports corresponding to an outer microwave radiation zone in an outward direction from a center of the top wall.

4. The microwave heating apparatus of claim 3, wherein the two microwave introduction ports corresponding to the inner microwave radiation zone are arranged such that their centers are disposed on a circumference of an inner circle of two virtual concentric circles, and the two microwave introduction ports corresponding to the outer microwave radiation zone are arranged such that their centers are disposed on a circumference of an outer circle of the two virtual concentric circles.

5. The microwave heating apparatus of claim 3, wherein the first to the fourth microwave introduction port are arranged such that central axes parallel to the long sides of two microwave introduction ports which are adjacent to each other are perpendicular to each other, and the central axes of two microwave introduction ports which are not adjacent to each other do not overlap each other on a same straight line.

6. The microwave heating apparatus of claim 1, wherein the microwave introduction ports are arranged such that distances from a center of the top wall are different from each other in the outward direction from a center of the top wall.

7. The microwave heating apparatus of claim 1, wherein a ratio L₁/L₂ of a length L₁ of the long sides to a length L₂ of the short sides of each of the microwave introduction ports is equal to or greater than 4.

8. The microwave heating apparatus of claim 1, wherein the microwave introducing device includes at least one waveguide for transmitting the microwaves toward the processing chamber, and an adapter member which is mounted on an outside of the top wall of the processing chamber and includes a plurality of metallic block bodies, and
wherein the adapter member further includes at least one waveguide path for transmitting microwaves therein, the waveguide path having a substantially S-shape.

9. The microwave heating apparatus of claim 8, wherein one end of the waveguide path is connected to a corresponding waveguide and the other end of the waveguide path is connected to a corresponding microwave introduction port, and the waveguide is connected to the corresponding microwave introduction port such that they do not overlap each other at least partially in a vertical direction.

10. A processing method for heating a target object to be processed by using a microwave heating apparatus which includes a processing chamber configured to accommodate the target object, the processing chamber having a microwave irradiation space, a support device configured to support the target object in the processing chamber, and a microwave introducing device configured to generate microwaves for heating the target object and introduce the microwaves into the processing chamber,
wherein the processing chamber further has a top wall, a bottom wall, and four sidewalls connected to each other,
wherein the top wall has a plurality of microwave introduction ports through which the microwaves generated in the microwave introducing device are introduced into the processing chamber,
wherein each of the microwave introduction ports is formed in a rectangular shape having long sides and short sides in a plan view, the long sides and the short sides being parallel to inner wall surfaces of the four sidewalls,
wherein the support device has a support member in contact with the target object to support the target object, and a rotating mechanism for rotating the target object supported by the support member,
wherein the microwave introduction ports are divided into microwave introduction ports corresponding to an inner microwave radiation zone and microwave introduction ports corresponding to an outer microwave radiation zone in a direction outward from a center of the top wall, and
wherein the target object is processed by introducing microwaves from each of the microwave introduction ports while rotating the target object supported by the support member by the rotating mechanism.

11. The processing method of claim 10, wherein the support device further has a vertical position adjusting mechanism to adjust a vertical position of the target object supported by the support member, and
wherein the processing method comprises a first step of setting the vertical position of the target object to a first vertical position by the vertical position adjusting mechanism and processing the target object, and a second step of setting the vertical position of the target object to a second vertical position different from the first vertical position by the vertical position adjusting mechanism and processing the target object.
